(19) United States
(12) Patent Application Publication
(10) Pub. No.: US 2015/0066711 A1
(43) Pub. Date: Mar. 5, 2015

(54) METHODS, APPARATUSES AND COMPUTER-READABLE MEDIUMS FOR ORGANIZING DATA RELATING TO A PRODUCT

(71) Applicant: National University of Singapore, Singapore (SG)

(72) Inventors: Tat Seng Chua, Singapore (SG); Jianxing Yu, Singapore (SG); Zheng-Jun Zha, Singapore (SG); Meng Wang, Singapore (SG)

(21) Appl. No.: 14/394,462

(22) PCT Filed: Apr. 9, 2013
(86) PCT No.: PCT/SG2013/000141

§ 371 Date: Oct. 14, 2014

Related U.S. Application Data
(60) Provisional application No. 61/622,970, filed on Apr. 11, 2012.
(60) Provisional application No. 61/622,972, filed on Apr. 11, 2012.

(51) Int. Cl. G06Q 10/08; G06F 17/27

(52) U.S. Cl. CPC G06Q 10/087; G06F 17/2785
USPC 705/28

(57) ABSTRACT

Various embodiments relate to methods, apparatuses and computer-readable mediums for organizing data relating to a product. An embodiment relates to a method for generating a modified hierarchy for a product based on data relating to the product. The method includes generating an initial hierarchy for the product, the initial hierarchy comprising a plurality of nodes, each node representing a different product aspect, the plurality of nodes being interconnected in dependence on relationships between different product aspects. The method also includes identifying a product aspect from the data. The method additionally includes determining an optimal position in the initial hierarchy for the identified product aspect by computing an objective function. The method further includes inserting the identified product aspect into the optimal position in the initial hierarchy to generate the modified hierarchy.

### TECHNICAL FIELD

Various embodiments relate to methods, apparatuses and computer-readable mediums for organizing data relating to a product. In particular, embodiments relate to: a method for generating a modified hierarchy for a product based on data relating to the product; a method for identifying product aspects based on data relating to the product; a method for determining an aspect sentiment for a product aspect from data relating to the product; a method for ranking product aspects based on data relating to the product; a method for determining a product sentiment from data relating to the product; a method for generating, a product review summary based on data relating to the product; and, together with corresponding apparatuses and computer-readable mediums.

### BACKGROUND

Organising of data relating to a product makes the data more understandable. The data may include text, graphics, tables and the like. For example, messages or information within the data may become clearer if the data is organised. Depending on the method of organisation, different messages or information within the data may become clearer. As the volume of data increases so does the need to organise the data in order to identify messages, information, themes, topics, trends within the data.

The data relating to the product may refer to one or more different aspects (i.e. features) of the product. For example, if the product is a cellular phone, exemplary product aspects may include: usability, size, battery performance, processing performance and weight. The data may include comments or reviews on the product and, more specifically, on individual aspects of the product.

### SUMMARY

A first aspect provides a method for generating a modified hierarchy for a product based on data relating to the product, the method comprising: generating an initial hierarchy for the product, the initial hierarchy comprising a plurality of nodes, each node representing a different product aspect, the plurality of nodes being interconnected in dependence on relationships between different product aspects; identifying a product aspect from the data; determining an optimal position in the initial hierarchy for the identified product aspect by computing an objective function; and inserting the identified product aspect into the optimal position in the initial hierarchy to generate the modified hierarchy.

A second aspect provides an apparatus for generating a modified hierarchy for a product based on data relating to the product, the apparatus comprising: at least one processor; and at least one memory including computer program code; the at least one memory and the computer program code configured to, with the at least one processor, cause the apparatus at least to: generate an initial hierarchy for the product, the initial hierarchy comprising a plurality of nodes, each node representing a different product aspect, the plurality of nodes being interconnected in dependence on relationships between different product aspects; identify a product aspect from the data; determine an optimal position in the initial hierarchy for the identified product aspect by computing an objective function; and insert the identified product aspect into the optimal position in the initial hierarchy to generate the modified hierarchy.

A third aspect provides a computer-readable storage medium having stored thereon computer program code which when executed by a computer causes the computer to execute a method for generating a modified hierarchy for a product based on data relating to the product, the method being in accordance with the first aspect.

A fourth aspect provides a method for identifying product aspects based on data relating to the product, the method comprising: identifying a data segment from a first portion of the data; generating a modified hierarchy based on a second portion of the data, in accordance with the first aspect; and classifying the data segment into one of a plurality of aspect classes, each aspect class being associated with a product aspect represented by a different node in the modified hierarchy to identify to which product aspect the data segment relates.

A fifth aspect provides an apparatus for identifying product aspects based on data relating to the product, the apparatus comprising: at least one processor; and at least one memory including computer program code; the at least one memory and the computer program code configured to, with the at least one processor, cause the apparatus at least to: identify a data segment from a first portion of the data; generate a modified hierarchy based on a second portion of the data using the apparatus of the second aspect; and classify the data segment into one of a plurality of aspect classes, each aspect class being associated with a product aspect represented by a different node in the modified hierarchy to identify to which product aspect the data segment relates.

A sixth aspect provides a computer-readable storage medium having stored thereon computer program code which when executed by a computer causes the computer to execute a method for identifying product aspects based on data relating to the product, the method being in accordance with the fourth aspect.

A seventh aspect provides a method for determining an aspect sentiment for a product aspect from data relating to the product, the method comprising: identifying a data segment from a first portion the data; generating a modified hierarchy based on a second portion of the data, in accordance with the first aspect; classifying the data segment into one of a plurality of aspect classes, each aspect class being associated with a product aspect represented by a different node in the modified hierarchy to identify to which product aspect the data segment relates; extracting from the data segment an opinion corresponding to the product aspect to which the data segment relates; classifying the extracted opinion into one of a plurality of opinion classes, each opinion class being associated with a different opinion, the aspect sentiment being the opinion associated with the one opinion class.

An eighth aspect provides an apparatus for determining an aspect sentiment for a product aspect from data relating to the product, the apparatus comprising: at least one processor; and at least one memory including computer program code; the at least one memory and the computer program code configured to, with the at least one processor, cause the apparatus at least to: identify a data segment from a first portion the data; generate a modified hierarchy based on a second portion of the data using the apparatus of the second aspect; classify the data segment into one of a plurality of aspect classes, each aspect class being associated with a product aspect represented by a different node in the modified hierarchy to identify to which product aspect the data segment relates; extract from the data segment an opinion corresponding to the product aspect to which the data segment relates; and classify the extracted opinion into one of a plurality of opinion classes, each opinion class being associated with a different opinion, the aspect sentiment being the opinion associated with the one opinion class.

A ninth aspect provides a computer-readable storage medium having stored thereon computer program code which when executed by a computer causes the computer to execute a method for determining an aspect sentiment for a product aspect from data relating to the product, the method being in accordance with the seventh aspect.

A tenth aspect provides a method for ranking product aspects based on data relating to the product, the method comprising: identifying product aspects from the data; generating a weighting factor for each identified product aspect based on a frequency of occurrence of the product aspect in the data and a measure of influence of the identified product aspect; and ranking the identified product aspects based on the generated weighting factors.

An eleventh aspect provides an apparatus for ranking product aspects based on data relating to the product, the apparatus comprising: at least one processor; and at least one memory including computer program code; the at least one memory and the computer program code configured to, with the at least one processor, cause the apparatus at least to: identify product aspects from the data; generate a weighting factor for each identified product aspect based on a frequency of occurrence of the product aspect in the data and a measure of influence of the identified product aspect; and rank the identified product aspects based on the generated weighting factors.

A twelfth aspect provides a computer-readable storage medium having stored thereon computer program code which when executed by a computer causes the computer to execute a method for ranking product aspects based on data relating to the product, the method being in accordance with the tenth aspect.

A thirteenth aspect provides a method for determining a product sentiment from data relating to the product, the method comprising: determining ranked product aspects relating to the product based on a first portion of the data in accordance with the tenth aspect; identifying one or more features from a second portion of the data, the or each feature identifying a ranked product aspect and a corresponding opinion; classifying each feature into one of a plurality of opinion classes based on its corresponding opinion, each opinion class being associated with a different opinion; and determining the product sentiment based on which one of the plurality of opinion classes contains the most features.

A fourteenth aspect provides an apparatus for determining a product sentiment from data relating to the product, the apparatus comprising: at least one processor; and at least one memory including computer program code; the at least one memory and the computer program code configured to, with the at least one processor, cause the apparatus at least to: determine ranked product aspects relating to the product based on a first portion of the data using the apparatus of the eleventh aspect; identify one or more features from a second portion of the data, the or each feature identifying a ranked product aspect and a corresponding opinion; classify each feature into one of a plurality of opinion classes based on its corresponding opinion, each opinion class being associated with a different opinion; and determine the product sentiment based on which one of the plurality of opinion classes contains the most features.

A fifteenth aspect provides a computer-readable storage medium having stored thereon computer program code which when executed by a computer causes the computer to execute a method for determining a product sentiment from data relating to the product, the method being in accordance with the thirteenth aspect.

A sixteenth aspect provides a method for generating a product review summary based on data relating to the product, the method comprising: determining ranked product aspects relating to the product based on a first portion of the data in accordance with the tenth aspect; extracting one or more data segments from a second portion of the data, calculating a relevance score for the or each extracted data segment based on whether the data segment identifies a ranked product aspect and contains a corresponding opinion; and, generating a product review summary comprising one or more of the extracted data segments in dependence on their respective relevance scores.

A seventeenth aspect provides an apparatus for generating a product review summary based on data relating to the product, the apparatus comprising: at least one processor; and at least one memory including computer program code; the at least one memory and the computer program code configured to, with the at least one processor, cause the apparatus at least to: determine ranked product aspects relating to the product based on a first portion of the data using the apparatus of the eleventh aspect; extract one or more data segments from a second portion of the data, calculate a relevance score for the or each extracted data segment based on whether the data segment identifies a ranked product aspect and contains a corresponding opinion; and, generate a product review summary comprising one or more of the extracted data segments in dependence on their respective relevance scores.

An eighteenth aspect provides a computer-readable storage medium having stored thereon computer program code which when executed by a computer causes the computer to execute a method for generating a product review summary based on data relating to the product, the method being in accordance with the sixteenth aspect.

It is to be understood that in the following description, the further features and advantages of one aspect, for example, a method, are equally applicable and are hereby restated in respect of corresponding aspects, for example, a corresponding apparatus or a corresponding computer-readable medium.

### BRIEF DESCRIPTION OF THE DRAWINGS

Embodiments of the invention will be better understood and readily apparent to one of ordinary skill in the art from the following written description, by way of example only, and in conjunction with the drawings, wherein like reference signs relate to like components, in which:

FIG. 1 shows an exemplary product specification from Wikipedia;

FIG. 2 shows an exemplary product specification from CNet.com;

FIG. 3a is a flow diagram of a framework for hierarchical organization in accordance with an embodiment;

FIG. 3b shows in exemplary hierarchical organization for iPhone 3G product in accordance with an embodiment;

FIG. 4 shows an exemplary consumer review from website Viewpoints.com;

FIG. 5 shows an exemplary consumer review from website Reevoo.com;

FIG. 6 is a flow diagram of a framework for product aspect identification in accordance with an embodiment;

FIG. 7 shows exemplary external linguistic resources from Open Directory Project (ODP);

FIG. 8 shows exemplary external linguistic resources from WordNet;

FIG. 9 is a flow diagram of a framework for sentiment classification in accordance with an embodiment;

FIG. 10 shows evaluation data relating to statistics of an exemplary product review dataset, # denotes the number of the reviews/sentences;

FIG. 11 shows evaluation data relating to statistics of exemplary external linguistic resources;

FIG. 12 shows evaluation data relating to performance of product aspect identification on free text reviews;

FIG. 13 shows evaluation data relating to performance of aspect hierarchy generation. It is noted that ‘w/H’ denotes the methods with initial hierarchy, and ‘w/o H’ refers to the methods without initial hierarchy;

FIG. 14 shows evaluation data relating to the impact of different proportion of initial hierarchy;

FIG. 15 shows evaluation data relating to multiple optimization criteria. % of change in F1-measure when a single criterion is removed;

FIG. 16 shows evaluation data relating to the impact of linguistic features for semantic distance learning;

FIG. 17 shows evaluation data relating to the impact of external linguistic resources for semantic distance learning;

FIG. 18 shows evaluation data relating to the performance of aspect-level sentiment classification;

FIG. 19 is a flow diagram of a framework for product aspect identification with a generated hierarchy in accordance with an embodiment;

FIG. 20 shows evaluation data relating to the performance of aspect identification with the help of a generated hierarchy;

FIG. 21 shows evaluation data relating to the performance of implicit aspect identification with the help of hierarchy;

FIG. 22 is a flow diagram of a framework for sentiment classification on aspects using the hierarchy in accordance with an embodiment;

FIG. 23 shows evaluation data relating to the performance of aspect-level sentiment classification with the help of hierarchy;

FIG. 24 shows numerous example aspects on an example product iPhone 3GS;

FIG. 25 is a flow diagram of a framework for aspect ranking in accordance with an embodiment;

FIG. 26 shows pseudo code of a probabilistic aspect ranking algorithm in accordance with an embodiment;

FIG. 27 shows evaluation data relating to the performance of aspect ranking in terms of NDCG@5;

FIG. 28 shows evaluation data relating to the performance of aspect ranking in terms of NDCG@10;

FIG. 29 shows evaluation data relating to the performance of aspect ranking in terms of NDCG@15;

FIG. 30 shows evaluation data comprising a table showing the top 10 aspects ranked by four methods for iPhone 3GS;

FIG. 31 shows an exemplary review document on the example product iPhone 4;

FIG. 32 is a flow diagram of a framework for document-level sentiment classification with aspect ranking results in accordance with an embodiment;

FIG. 33 shows evaluation data relating to the performance of document-level sentiment classification by the three feature weighting methods, i.e., Boolean, Term Frequency (TF), and our proposed aspect ranking AR weighting;

FIG. 34 is a flow diagram of a framework for extractive review summarization with aspect ranking results in accordance with an embodiment;

FIGS. 35a and 35b show evaluation data relating to the performance of extractive review summarization in terms of ROUGE-1 (35a) and ROUGE-2 (35b);

FIG. 36 shows evaluation data comprising a table showing sample extractive summaries on product iPhone 3GS; and,

FIG. 37 is a schematic diagram of a computer network apparatus in accordance with an embodiment.

### DETAILED DESCRIPTION

Various embodiments relate to methods, apparatuses and computer-readable mediums for organizing data relating to a product. In particular, embodiments relate to a method for generating a modified hierarchy, a method for identifying product aspects, a method for determining an aspect sentiment, a method for ranking product aspects, a method for determining a product sentiment, a method for generating a product review summary and to corresponding apparatuses and computer-readable mediums.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “identifying”, “extracting”, “ranking”, “calculating”, “determining”, “replacing”, “generating”, “inserting”, “classifying”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatuses for performing the operations of the methods. Such apparatuses may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

Overview of Hierarchy Framework

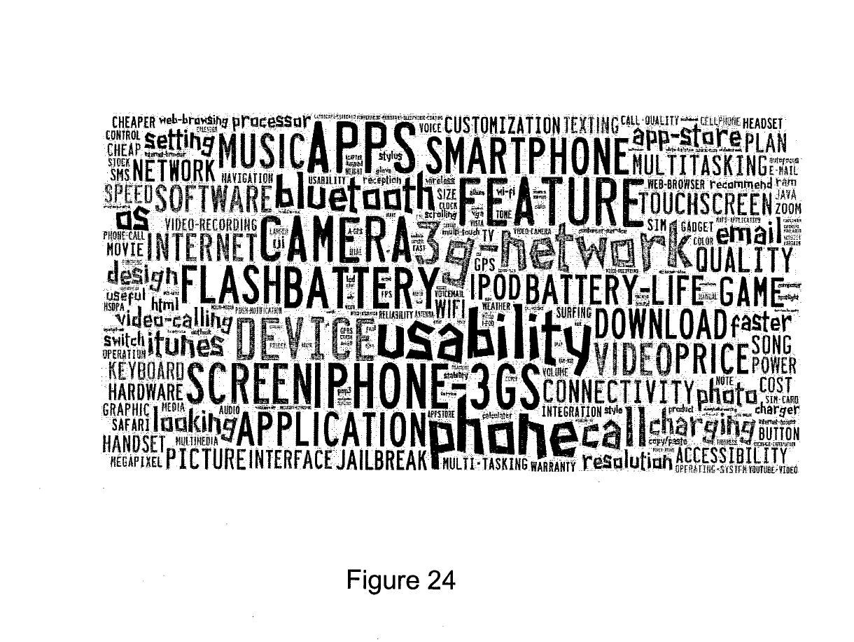

For a certain product, the hierarchy usually categorizes hundreds of product aspects. For example, iPhone 3GS has more than three hundred aspects (see FIG. 24), such as “usability,” “design,” “application,” “3G network” etc. Some aspects may be more important than the others, and have greater impact on the eventual consumers' decision making as well as the firms' product development strategies. For example, some aspects in iPhone 3GS such as “usability” and “battery” are of concerns to most consumers, and are more important than the others such as “USB.” For a camera product, the aspects such as “lenses” and “picture quality” would greatly influence consumer opinions on the camera, and they are more important than the aspects such as “a/v cable” and “wrist strap.” Hence, identifying important product aspects is beneficial to both consumers and firms. Consumers can conveniently make wise purchasing decision by paying more attentions to the important aspects, while firms can focus on improving the quality of these aspects and thus enhance product reputation effectively. Generally, it is impractical for people to manually identify important aspects of a product from numerous reviews.

Various embodiments relate to the organization of data relating to a product. In particular, embodiments relate to a method for generating a modified hierarchy, a method for identifying product aspects, a method for determining an aspect sentiment, and to corresponding apparatuses and computer-readable mediums.

The ‘product’ may be any good or item for sale, such as, for example, consumer electronics, food, apparel, vehicle, furniture or the like. More specifically, the product may be a cellular telephone.

The ‘data’ may include any information relating to the product, such as, for example, a specification, a review, a fact sheet, an instruction manual, a product description, an article on the product, etc. The data may include text, graphics, tables or the like, or any combination thereof. The data may refer generally to the product and, more specifically, to individual product aspects (i.e. features). The data may contain opinions (i.e. views) or comments on the products and its product aspects. The opinions may be discrete (e.g. good or bad, or on an integer scale of 1 to 10) or more continuous in nature. The product, opinions and aspects may be derivable from the data as text, graphics, tables or any combination thereof.

In the following embodiment, the data may include reviews (e.g. consumer reviews) of the product. The reviews may be unorganized, leading to difficulty in navigation and knowledge acquisition.

For the task of generating a review hierarchy from the data, it is possible to refer to traditional methods in the domain of ontology learning, which first identify the concepts from text, then determine the parent-child relations among these concepts using either pattern-based or clustering-based methods. However, pattern-based methods usually suffer from inconsistency of the parent-child relations among concepts, while clustering-based methods often result in low accuracy. Thus, by directly utilizing these methods to generate an aspect hierarchy from reviews, the resulting hierarchy is usually inaccurate, leading to unsatisfactory review organization. Moreover, the generated hierarchy may not be consistent with the information needs of the users which expect certain sub-topics to be present.

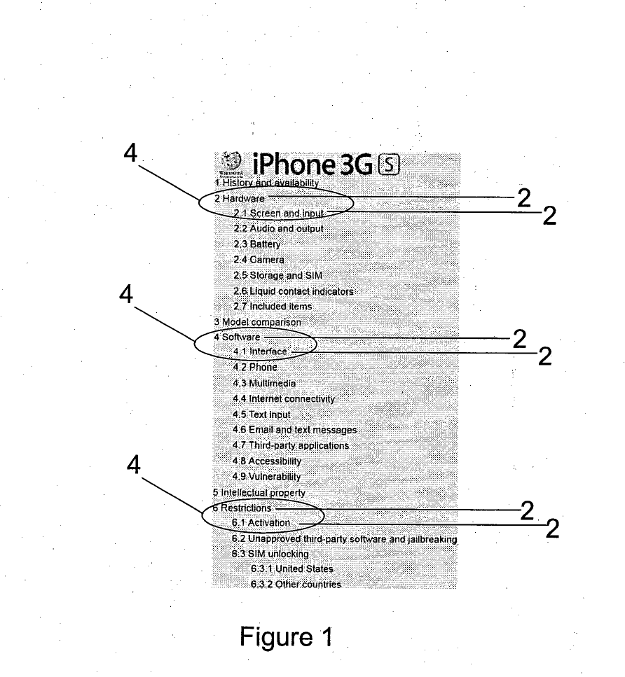

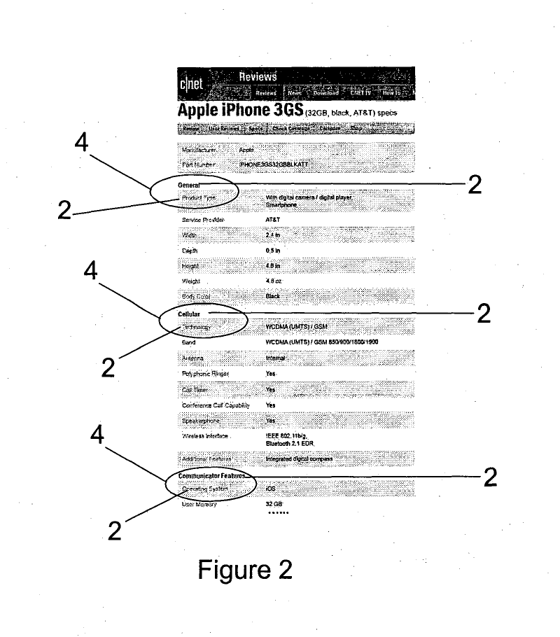

On the other hand, domain knowledge of products may be available on the Web. Domain knowledge may be understood as information about a certain product. The information may be taken from the public domain. This knowledge may provide a broad structure that may answer the users' key information needs. For example, there are more than 248,474 product specifications in the forum website CNet.com. FIG. 1 and FIG. 2 show the product specifications of the cellular phone product “iPhone 3GS” in Wikipedia (www.wikipedia.com) and CNet.com, respectively. These product specifications cover some product aspects 2 (i.e. aspects or features of the product) and provide coarse-grained parent-child relations 4 among the aspects 2. Such domain knowledge is useful to help organize the product aspects into a hierarchy. While the initial hierarchy obtained from domain knowledge is good for broad structure of review organization, it is often too coarse and does not cover the specific product aspects commented in reviews (e.g. consumer reviews). Moreover, some aspects in the hierarchy may not be of interest to users in the reviews. In order to take advantage of the best of both worlds, it is possible to integrate the initial domain knowledge structure, which reflects broad user interests in the product, and the distribution of reviews, that indicates current interests and topics of concerns to users. Hence the initial review hierarchy can be evolved into a modified hierarchy that reflects current users' opinions and interests.

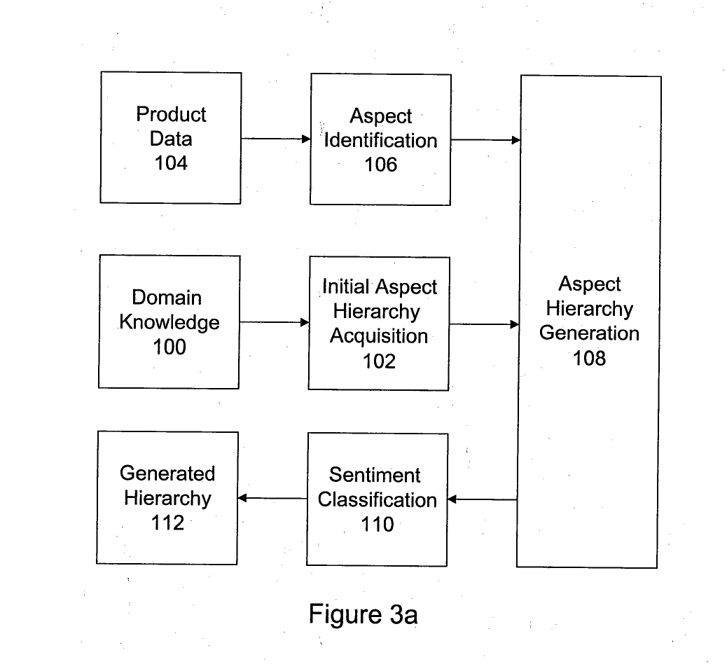

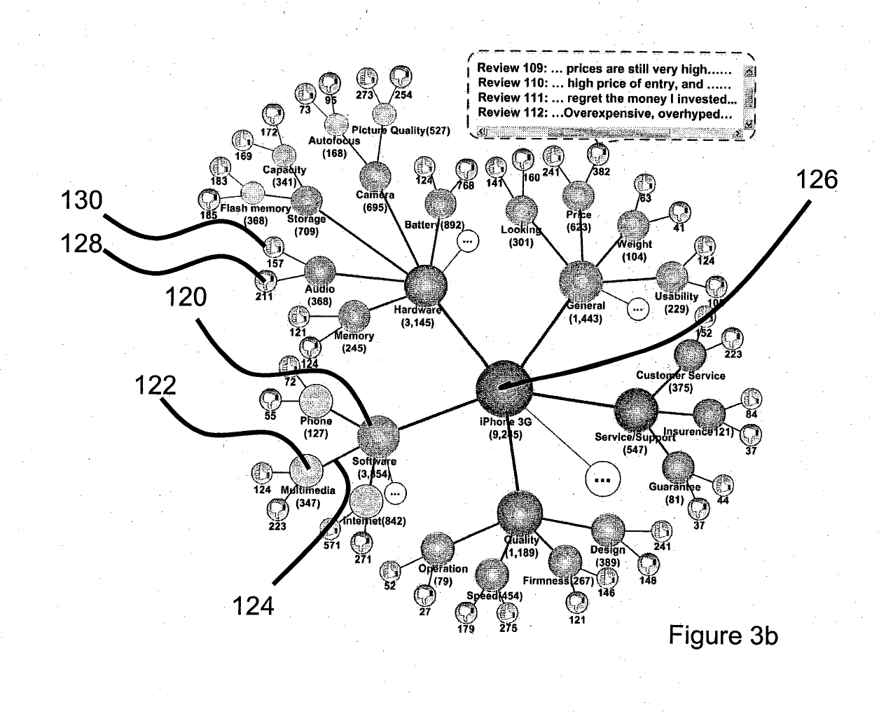

An embodiment provides a domain-assisted approach to generate a review hierarchical organization by simultaneously exploiting the domain knowledge (e.g., the product specification) and data relating to the product (e.g. consumer reviews). The framework of this embodiment is illustrated in the flow diagram of FIG. 3.

At 100, domain knowledge is sought to determine a course description of a certain product. For example, the domain knowledge may be obtained from one or more internet sites, such as, Wikipedia or CNet. At 102, this domain knowledge is used to acquire an initial aspect hierarchy, i.e. a hierarchy for organising product aspects relating to the product. Either in serial or in parallel with 100 and 102, at 104, data relating to the product (e.g. consumer reviews) is obtained, for example, from one or more internet sites. At 106, the obtained data is used to identify product aspects relating to the product.

At 108, a modified hierarchy is generated based on the initial hierarchy developed in 102 and the product aspects identified in 106. In an embodiment, an optimization approach is used to incrementally insert the aspects identified in 106 into appropriate positions of the initial hierarchy developed in 102 to obtain an aspect hierarchy that includes all the aspects, i.e. a modified hierarchy. In this way, the data obtained in 104 is then organized into corresponding aspect nodes in the modified hierarchy developed in 108. The optimum position for an aspect is obtained by computing an objective function which aims to optimize one or more criteria. In an embodiment, multi-criteria optimization is performed.

At 110, sentiment classification may be performed to determine consumer opinions on the aspects. The opinions may be extracted from the data relating to the product. At 112, the sentiments may be added to the hierarchy to obtain a more detailed hierarchical organization, i.e. one which includes opinion or sentiment. In an embodiment, the method may be performed by a general purpose computer with a display screen, or a specially designed hardware apparatus having a display screen. Accordingly, at 112, the modified hierarchy may be sent to a display screen for display to a human user. FIG. 3b shows a modified hierarchy in accordance with an embodiment.

In the embodiment of FIG. 3b, the hierarchy relates to a particular product (e.g. iPhone 3G) and includes multiple nodes, wherein each node represents a different product aspect. For example, a node 120 (representing product aspect ‘software’) and a node 122 (representing product aspect ‘multimedia’) are indicated. Nodes 120 and 122 represent a node pair which is connected together by connection 124. The connection 124 indicates a parent-child relationship between the product aspects represented by nodes 120 and 122. The parent node is node 120 (i.e. software) since it is closer to a root node 126 than the child node 122 (i.e. multimedia). The leaves or ends (e.g. 128 and 130) of the hierarchy may represent opinions on the product aspects of the nodes to which the leaves are connected.

Various embodiments provide a method for generating a modified hierarchy for a product based on data relating to the product (e.g. consumer review). The method includes the following. An initial hierarchy for the product is generated, the initial hierarchy comprising a plurality of nodes, each node representing a different product aspect, the plurality of nodes being interconnected in dependence on relationships between different product aspects. A product aspect is identified from the data. An optimal position in the initial hierarchy for the identified product aspect is determined by computing an objective function. The identified product aspect is inserted into the optimal position in the initial hierarchy to generate the modified hierarchy.

In an embodiment, the initial hierarchy is generated based on a specification of the product, for example, a specification obtained from a website, such as, Wikipedia or CNet.

In an embodiment, the initial hierarchy comprises one or more node pairs, each node pair having a parent node and a child node connected together to indicate a parent-child relationship. In an embodiment, the initial hierarchy comprises a root node and the parent node of the or each node pair is the node closest to the root node. This may be the closest in terms of proximity or the closest in terms of the minimum number of intervening nodes to the root node.

In an embodiment, inserting the identified product aspect into the initial hierarchy comprises associating the identified product aspect with an existing node to indicate that the existing node represents the identified product aspect. In an embodiment, inserting the identified product aspect into the initial hierarchy comprises interconnecting a new node into the initial hierarchy and associating the identified product aspect with the new node to indicate that the new node represents the identified product aspect. For example, the before insertion, node A may be connected to node B to form a node pair. Node A may be the parent node whereas node B may be the child node. For example, node A may represent the product aspect ‘hardware’ whereas node B may represent the product aspect ‘memory’. The new node may be associated with the new product aspect ‘capacity’, i.e. memory capacity. Accordingly, a new node C may be added as a child of node B, thereby representing that ‘capacity’ is a child feature of parent feature ‘memory’.

Hierarchical Organization Framework

As illustrated in FIG. 3, an embodiment includes four components: (a) initial aspect hierarchy acquisition; (b) product aspect identification; (c) aspect hierarchy generation; and (d) sentiment classification on product aspects. The following defines some notations and elaborates these components.

Preliminary and Notations

In an embodiment, an aspect hierarchy may be a tree that consists of a set of nodes. Each node may represent (or be associated with) a unique product aspect. Furthermore, there may be a set of parent-child relations R among these nodes and the aspects which they represent. For example, two adjacent nodes may be interconnected to indicate a parent child relationship between the two aspects represented by the two nodes (or node pair). The parent node may be the node closest to a root node of the hierarchy. In an embodiment, closest may mean physically closer or simply that there are fewer nodes in-between.

In an embodiment, given the consumer reviews of a product, let A={a₁, . . . , aₖ} denote the product aspects commented in the reviews. H⁰(A⁰,R⁰) denotes the initial hierarchy acquired from domain knowledge. It contains a set of aspects A⁰ and relations R⁰. Various embodiments aim to construct an aspect hierarchy H(A,R), to include all the aspects in A and their parent-child relations R, so that all the consumer reviews can be hierarchically organized. Note that H⁰ can be empty.

Initial Hierarchy Acquisition

As aforementioned, product specifications in some forum websites (e.g. Wikipedia, CNet) cover some product aspects and coarse-grained parent-child relations among these aspects. Such domain knowledge is useful to help organize aspects into a hierarchy.

In an embodiment, an initial aspect hierarchy is automatically acquired from the product specifications. The method first identifies the Web page region covering product descriptions and removes the irrelevant contents from the Web page. It then parses the region containing the product information based on the HTML tags, and identifies the aspects as well as their structure. By leveraging the aspects and their structure, it generates an initial aspect hierarchy.

Product Aspect Identification

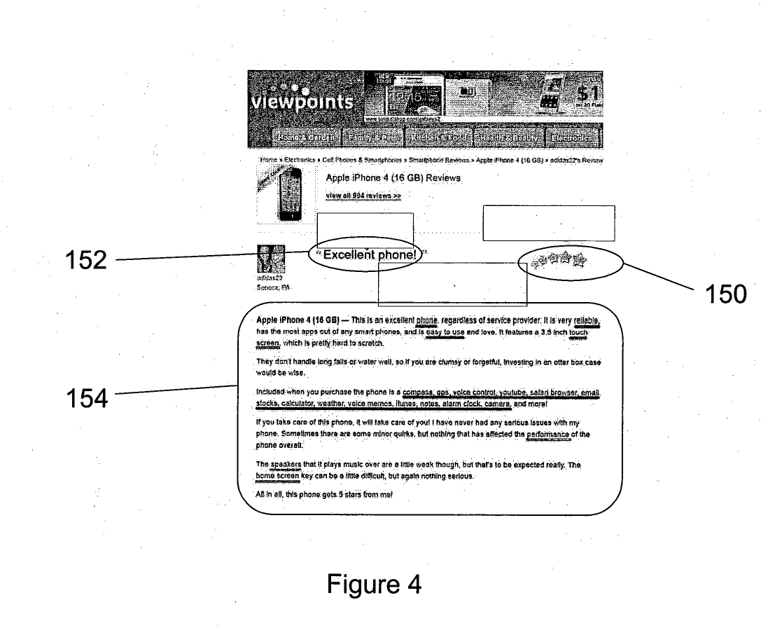

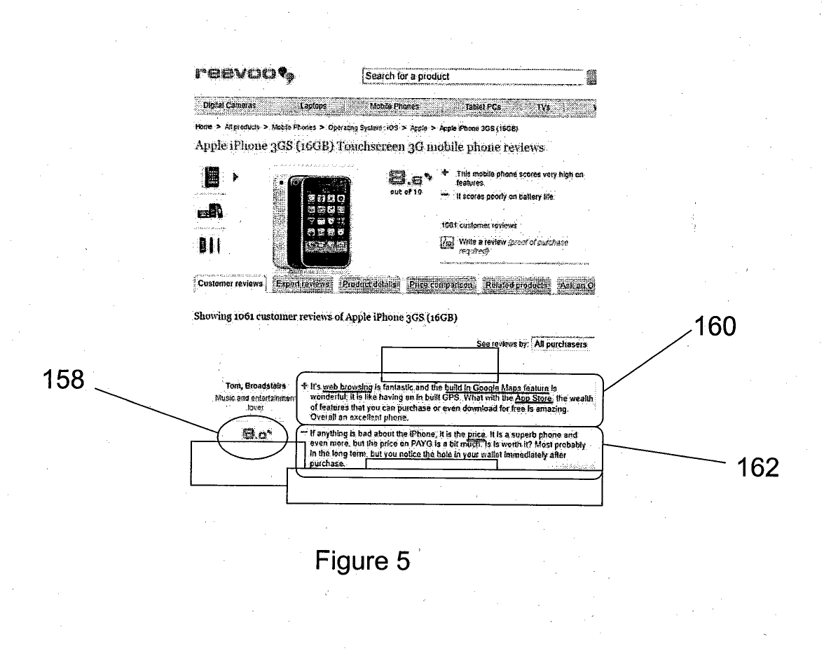

As illustrated in FIGS. 4 and 5, consumer reviews are composed of different formats on forum Websites. For example, websites such as CNet.com require consumers to give an overall rating of the product, and provide summary data or concise positive and negative opinions (i.e. Pros and Cons) on some product aspects, as well as write a paragraph of detailed review in free text 156. As seen more particularly on FIG. 4, some other websites, such as Viewpoints.com, only ask for an overall rating 150, a headline-like title 152 and a paragraph of free-text review 154. As seen more particularly on FIG. 5, some other websites, such as Reevoo.com, involve an overall rating 158 and concise positive 160 and negative opinions 162 on some aspects.

In summary, besides overall rating, a consumer review may consist of summary data (e.g. Pros and Cons), free text review, or both. For summary data (e.g. Pros and Cons reviews), aspects may be identified by extracting the frequent noun terms. In this way, it is possible to obtain highly accurate aspects by extracting frequent noun terms from summary data. Further, these frequent terms are helpful for identifying aspects in the free text reviews.

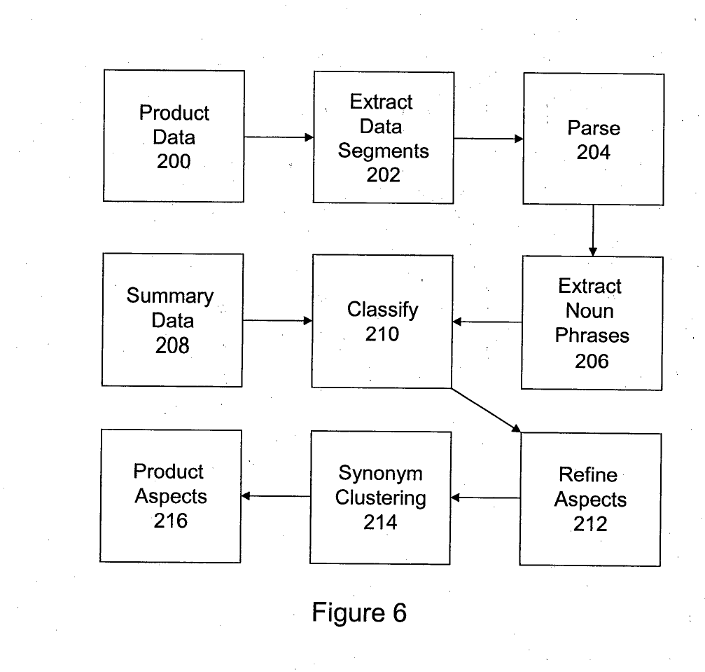

FIG. 6 is a flow diagram of a method for identifying product aspects in accordance with an embodiment. The following describes the details of this method.

At 200 consumer reviews are obtained as proposed above. It is to be understood in this embodiment that the consumer reviews represent data relating to a certain product. The data may be obtained from various Internet sites. At 202, data segments are extracted from the data obtained in 200. For example, the free text review portion 154 of each consumer review obtained in 200 may be split into sentences. At 204, each data segment (e.g. sentence) may be parsed, for example, using a Stanford parser. This parsing operation may be used to identify and remove irrelevant content from the data.

At 206, frequent noun phrases (NP) may then be extracted from the data segment parse trees as aspect candidates. It is to be understood that a noun phrase is a specific type of data segment extracted from the data. Therefore, in other embodiments, data segments (rather than noun phrases) may be extracted from the data.

These NP candidates may contain noise (i.e. NPs which are not aspects). However, other portions of the reviews, such as summary data (e.g. Pros 160 reviews and Cons reviews 162), may be leveraged to refine the candidates since these other portions may more clearly identify product aspects. In particular, at 208, the summary data may be obtained. At 210, the frequent noun terms in the summary data may be explored as features, and used to train a classifier. For example, suppose N frequent noun terms are collected in total, each frequent noun term may be treated as one sample. That is, each frequent noun term may be represented into an N dimension vector with only one dimension having value 1 and all the others 0. Based on such a representation, a classifier can be trained. The classifier can be. Support Vector Machine (SVM), Naïve Bayes and Maximum Entropy model. In an embodiment, the classifier is a one-class Support Vector Machine (SVM), such that a NP candidate is classified as an aspect or not classified.

It is to be understood that in some other embodiments, Pros and Cons reviews may not be necessary. Instead, some other data (e.g. text, graphics, tables, etc.) may be provided which can be relied upon to clearly identify product aspects with associated opinions. This data may be referred to generally as ‘summary data’, wherein Pros and Cons reviews may be a specific form of summary data. This data may be known as summary data since it summarizes product aspects and corresponding opinions thereon. The summary data may be extracted from the data obtained at 200.

At 212, the trained classifier may be used to identify the true aspects in the candidates. It is to be understood that this process may be more than just a simple comparison of each candidate with each aspect identified in the summary data. Instead, this process may employ machine learning to judge whether or not a new term is the same as a different but corresponding term included in the summary data.

The obtained aspects may contain some synonym terms, such as, for example, “earphone” and “headphone”. Accordingly, at 214, synonym clustering may be further performed to obtain unique aspects. Technically, the distance between two aspects may be measured by Cosine similarity. The synonym terms relating to the obtained aspects may be extracted from a synonym dictionary (e.g. http://thesaurus.com), and used as features for clustering. The resultant identified aspects are then collected in 216. In an embodiment, the method may be performed by a general purpose computer with a display screen, or a specially designed hardware apparatus having a display screen. Accordingly, at 216, the identified aspects may be sent to a display screen for display to a human user.

In an embodiment, identifying a product aspect from data relating to the product comprises extracting one or more noun phrases from the data.

In an embodiment, an extracted noun phrase is classified into an aspect class if the extracted noun phrase corresponds with a product aspect associated with the aspect class, the aspect class being associated with one or more different product aspects. In an embodiment, the term ‘correspond’ may include more than just ‘match’. For example, the classification process could identify noun phrases as corresponding to a particular product aspect even if the exact terms of the product aspect are not included in the noun phrase. For example, classification may be performed using a one-class SVM. In an embodiment, the aspect class may be associated with multiple (e.g. all) product aspects. In this way, the extracted noun phrase may be either classified or not classified depending on whether or not it is a product aspect. Accordingly true product aspects may be identified from the extracted noun phrases.

In a different embodiment, an extracted noun phrase may be classified into one of a plurality of aspect classes, each aspect class being associated with a different product aspect. In this way, an extracted noun phrase may be identified as being an identified product aspect or not.

In an embodiment, multiple different extracted noun phrases are clustered together, wherein each of the multiple different extracted noun phrases includes a corresponding synonym term. In this way, different noun phrases which relate to the same product aspect may be combined together. For example, various noun phrases may include the term ‘headphone’, whereas various other noun phrases may include the term ‘earphone’. Since ‘headphone’ and ‘earphone’ relate to the same product aspect, all these noun phrases may be combined together. In this embodiment, ‘headphone’ and ‘earphone’ are corresponding synonym terms. In an embodiment, the step of synonym clustering may be performed after the above-mentioned classifying step.

Generation of Aspect Hierarchy

To build the hierarchy, the newly identified aspects may be incrementally inserted into appropriate positions in the initial hierarchy. The optimal positions may be found by a multi-criteria optimization approach. Further details of this embodiment now follow.

Formulation

In an embodiment, given the aspects A={a₁, . . . , aₖ} identified from reviews and the initial hierarchy H⁰(A⁰,R⁰) acquired from the domain knowledge, a multi-criteria optimization approach is used to generate an aspect (i.e. modified) hierarchy H*, which allocates all the aspects in A, including those not in the initial hierarchy, i.e. A-A⁰. The approach incrementally inserts the newly identified aspects into the appropriate positions in the initial hierarchy. The optimal positions are found by multiple criteria. The criteria should guarantee that each aspect would most likely to be allocated under its parent aspect in the hierarchy.

Before introducing the criteria, it is first necessary to define a metric, named Semantic Distance, d(aₓ,a_{y}), to quantify the parent-child relations between aspects aₓ and a_{y}. d(aₓ,a_{y}) is formulated as the weighted sum of some underlying features,

d(aₓ,a_{y})=Σⱼωⱼƒⱼ(aₓ,a_{y}) (3.1)

where ωⱼ is the weight for j-th feature function ƒⱼ*(•). The estimation of the feature function ƒ(•), and the learning of d(aₓ,a_{y}) (i.e. weight ω) will be described later.

In addition, an information function Info(H) is introduced to measure the overall semantic distance of a hierarchy H. Info(H) is formulated as the sum of the semantic distances of all the aspect pairs in the hierarchy as,

Info(H(A,R))=Σ_{x<y; a}_{ₓ}_{,a}_{_{y}} _{∈A} d(aₓ,a_{y}) (3.2)

where the less sign “<” means the index of aspect aₓ is less than that of a_{y}. The information function does not double count the distance of the aspect pairs.

For each new aspect inserting into the hierarchy, it introduces a change in the hierarchy structure, which increases the overall semantic distance of the entire hierarchy. That is, information function Info(H) would increase, and it thus can be used to characterize the hierarchy structure. Based on Info(H), it is possible to introduce the following three criteria to find the optimal positions for aspect insertion: minimum Hierarchy Evolution, minimum Hierarchy Discrepancy and minimum Semantic Inconsistency.

Hierarchy Evolution is designed to monitor the structure evolution of a hierarchy. The hierarchy is incrementally hosting more aspects until all the aspects are allocated. The insertion of a new aspect into various positions in the current hierarchy H⁽ⁱ⁾ leads to different new hierarchies. It gives rise to different increase of the overall semantic distance (i.e. Info(H⁽ⁱ⁾)). When an aspect is placed into the optimal position in the hierarchy (i.e. as a child of its true parent aspect), Info(H⁽ⁱ⁾) has the least increase. In other words, minimizing the change of Info(H⁽ⁱ⁾) is equivalent to searching for the best position to insert the aspect. Therefore among the new hierarchies, the optimal one Ĥ⁽ⁱ⁺¹⁾ should lead to the least changes of overall semantic distance to H⁽ⁱ⁾, as follows,

Ĥ⁽ⁱ⁺¹⁾=arg min_{H}_{⁽ⁱ⁺¹⁾} ΔInfo(H⁽ⁱ⁺¹⁾−H⁽ⁱ⁾) (3.3)

The first criterion can be obtained by plugging Info(H) into Eq.(3.2) and using least square as the loss function to measure the information changes,

obj₁=arg min_{H}_{⁽ⁱ⁺¹⁾}(Σ_{x<y;a}_{ₓ}_{,a}_{_{y}}_{∈A}_{ⁱ}_{∪(a)}d(aₓ,a_{y})−Σ_{x<y;a}_{ₓ}_{,a}_{_{y}}_{∈A}_{ⁱ}d(aₓ,a_{y}))² (3.4)

Here a denotes the new aspect for insertion.

Hierarchy Discrepancy is used to measure the global changes of the structure evolution. A good hierarchy should be the one that brings the least changes to the initial hierarchy in a macro-view, so as to avoid the algorithm falling into a local minimum,

Ĥ⁽ⁱ⁺¹⁾=arg min_{H}_{⁽ⁱ⁺¹⁾} ΔInfo(H⁽ⁱ⁺¹⁾−H⁽⁰⁾/(i+1) (3.5)

By substituting Eq.(3.2), the second criterion can be obtained as:

$${obj}_{2} = arg {min}_{{H}^{( i + 1 )}} \frac{1}{i + 1} {( {\sum }_{x < y ; {a}_{x} , {a}_{y} ∈ {A}^{i} ⋃ \{ a \}} d ( {a}_{x} , {a}_{y} ) - {\sum }_{x < y ; {a}_{x} , {a}_{y} ∈ {A}^{0}} d ( {a}_{x} , {a}_{y} ) )}^{2} \qquad ( 3.6 )$$

Semantic Inconsistency is introduced to quantify the inconsistency between the semantic distance estimated via the hierarchy and that computed from the feature functions (i.e. Eq.(3.1)). The feature functions will be described in more detail later. The hierarchy should precisely reflect the semantic distance among aspects. For two aspects, their semantic distance reflected by the hierarchy is computed as the sum of all the adjacent interval distances along the shortest path between them,

d^{H}(aₓ,a_{y})=Σ_{p<q;(a}_{ₚ}_{,a}_{_{q}}_{)∈SP(a}_{ₓ}ₐ_{_{y}}₎d(aₚ,a_{q}) (3.7)

where SP(aₓ,a_{y}) is the shortest path between aspects aₓ and a_{y} via the common ancestor nodes, and (aₚ,a_{q}) represents all the adjacent nodes along the path.

The third criterion is then obtained to derive the optimal hierarchy,

obj₃=arg min_{H}_{⁽ⁱ⁺¹⁾}Σ_{x<y;a}_{ₓ}_{,a}_{_{y}}_{∈A∪(a)}(d^{H}(aₓ,a_{y)-}d(aₓ,a_{y}))² (3.8)

where d(aₓ,a_{y}) is the distance computed by the feature function in Eq.(3.1).

Multi-Criteria Optimization—Through integrating the above criteria, the multi-criteria optimization framework is formulated as,

obj=arg min_{H}_{⁽ⁱ⁺¹⁾}(λ₁·obj₁+λ₂·obj₂+λ₃·obj₃)

λ₁+λ₂+λ₃=1; 0≦λ₁,λ₂,λ₃≦1 (3.9)

where λ₁, λ₂, λ₃ are the trade-off parameters, which would be described later. All of the above criteria may be convex and, therefore, it may be possible to find an optimal solution with multi-criteria optimization by linearly integrating all the criteria.

To summarize the above-described embodiment, hierarchy generation starts from an initial hierarchy and inserts the aspects into it one-by-one until all the aspects are allocated. For each new aspect, an objective function is computed by Eq.(3.9) to find the optimal position for insertion. It is noted that the insertion order may influence the result. To avoid such influence, the aspect with the least objective value in Eq.(3.9) is selected for each insertion. Based on the resultant hierarchy, data (i.e. consumer reviews) may then be organized to their corresponding aspect nodes in the hierarchy. The nodes without reviews from the hierarchy may then be pruned out, i.e. removed.

The following description introduces the estimation of the feature function ƒ(aₓ,a_{y}) and the semantic distance d(aₓ,a_{y}).

In an embodiment, determining the optimal position in the hierarchy for an identified product aspect comprises: inserting the identified product aspect in each of a plurality of sample positions in the initial hierarchy; calculating a positioning score relating to each sample position, the positioning score being a measure of suitability of the sample position; and determining the optimal position based on the positioning scores relating to each sample position. In an embodiment, the optimal position minimizes the positioning score.

In an embodiment, the positioning score is a measure of change in a hierarchy semantic distance, the hierarchy semantic distance being a summation of an aspect semantic distance for each node pair in the hierarchy, each aspect semantic distance being a measure of similarity between the meanings of the two product aspects represented by the node pair. For example, the positioning score may be the Hierarchy evolution score (e.g. Eq. 3.4).

In an embodiment, the positioning score is a measure of change in the structure of the initial hierarchy. The term ‘structure’ may be taken to include the nodes of the hierarchy together with the interconnections of those nodes. The ‘interconnections’ may be taken to mean the connections between different node pairs in the hierarchy. For example, the positioning score may be the Hierarchy discrepancy score (e.g. Eq. 3.6).

In an embodiment, the positioning score is a measure of change between first and second aspect semantic distances relating to a node pair in the initial hierarchy, the first and second aspect semantic distances being a measure of similarity between the meanings of the two product aspects represented by the node pair, the first aspect semantic distance being calculated based on the hierarchy, i.e. computing the distance of the path connecting the node pair via the hierarchy, the second semantic distance being calculated based on auxiliary data relating to the product. In an embodiment, auxiliary data may be data relating to the product which has not been used in the formation of the hierarchy, e.g. not data 104 from FIG. 3. For example, the positioning score may be the semantic inconsistency score (e.g. Eq. 3.8).

According to the above, the positioning score may be dependent on one or more different criteria (e.g. Eq. 3.4, 3.6 and 3.8). The optimum positioning score may be determined by computing an objective function (e.g. Eq. 3.9) which aims to concurrently optimize each criterion. In this way, the optimum positioning score may be determined which optimizes each criterion (e.g. minimizes the positioning score). Accordingly, multi-criteria optimization may be performed.

Linguistic Features for Semantic Distance Estimation

In an embodiment, given two aspects aₓ and a_{y}, the feature is defined as a function ƒ(aₓ,a_{y}) generating a numeric score or a vector of scores. Multiple features are then explored including: Contextual, Co-occurrence, Syntactic, Pattern and Lexical features. These features are generated based on auxiliary documents (or data) collected from the Web. Specifically, each aspect and aspect pair is used as a query to an internet search engine (e.g. Google and Wikipedia), and the top one hundred (100) returned documents for each query are collected. Each document is split into sentences. Based on these documents and sentences, the features are generated as follows.

Contextual features. The meaning of terms tends to be similar if they appear in similar contexts. Thus, the following contextual features are exploited to measure the relations among the aspects. In an embodiment, two kinds of features are defined, including global context feature and local context feature. In particular, for each aspect, the hosted documents are collected and treated as context to build a unigram language model, with Dirichlet smoothing. Given two aspects aₓ and a_{y}, the Kullback-Leibler (KL) divergence between their language models is computed as their Global-Context feature. Similarly, the left two and right two words surrounding each aspect are collected, and used as context to build a unigram language model. The KL-divergence between the language models of two aspects aₓ and a_{y} is defined as the Local-Context feature.

Co-occurrence features. Co-occurrence is effective in measuring the relations among the terms. In an embodiment, the co-occurrence of two aspects aₓ and a_{y} is computed by Pointwise Mutual Information (PMI): PMI(aₓ,a_{y})=log(Count(aₓ,a_{y})/Count(aₓ)·Count(a_{y})), where Count(•) stands for the number of documents or sentences containing the aspect(s), or the number of document hits (from the above-mentioned internet search results) for the aspect(s). Based on different definitions of Count(•), it is possible to define the features of Document PMI, Sentence PMI, and Google PMI, respectively.

Syntactic features. These features are used to measure overlap of the aspects with regards to their neighbouring semantic roles. In an embodiment, the sentences that contain both aspects aₓ and a_{y} are collected, and parsed into the syntactic trees, for example, using a Stanford Parser. For each sentence, the length of the shortest path between aspects aₓ and a_{y} in the syntactic tree is computed. The average length is taken as Syntactic-path feature between aₓ and a_{y}. Accordingly, for each aspect, its hosted sentences are parsed, and its modifier terms from the sentence parse trees are collected. The modifier terms are defined as the adjective and noun terms on the left side of the aspect. The modifier terms that share the same parent node with the aspect are selected. The size of the overlaps between two modifiers sets for aspects aₓ and a_{y} are calculated as the Modifier Overlap feature. In addition, the hosted sentences are selected for each aspect, and semantic role labelling is performed on the sentences, for example, using an ASSERT parser. The subject role terms are collected from the labelling sentences as the subject set. Overlaps between two subject sets for aspects aₓ and a_{y} are then calculated as the Subject Overlap feature. For example, the aspect “camera” is treated as the object of the review “My wife quite loves the camera.” while “lens” is the object of “My wife quite loves the lens.” These two aspects have the same subject “wife”, and the subject is used to compute the Subject Overlap feature. Similarly, for other semantic roles (i.e. objects and verbs), the features of Object Overlap, and Verb Overlap are defined using a corresponding procedure.

Relation pattern features. In an embodiment, a group of n relation patterns may be used, wherein each pattern indicates a type relationship between two aspects. For example, the relationship may be a hypernym relationship or some other semantic relationship. In an embodiment, 46 relation patterns are used, including 6 patterns indicating the hypernym relations of two aspects, and 40 patterns measuring the part-of relations of two aspects. These pattern features are asymmetric, and they take into consideration the parent-child relations among aspects. However, it is to be understood that in some other embodiments, a different group of n relation patterns may be used. In any case, based on these patterns, a n-dimensional score vector may be obtained for aspects aₓ and a_{y}. A score may be 1 if two aspects match a pattern and 0 otherwise.

Lexical features. Word length impacts the abstractness of the words. For example, the general weird (e.g. the parent) is often shorter than the specific word (e.g. the child). The word length difference between aspects aₓ and a_{y} is computed as a Length Difference feature. In an embodiment, the query “define:aspect” is issued to an internet search engine (e.g. Google), and the definitions of each aspect (aₓ/a_{y}) are collected. The word overlaps between the definitions of two aspects aₓ and a_{y}, are counted as a Definition Overlap feature. This feature measures the similarity of the definitions for two aspects aₓ and a_{y}.

Estimation of Semantic Distance

As aforementioned, in an embodiment, the semantic distance d(aₓ,a_{y}) may be formulated as Σⱼωⱼƒⱼ(aₓ,a_{y}), where ω denotes the weight, and ƒ(aₓ,a_{y}) is the feature function. To learn the weight ω, it is possible to employ the initial hierarchy as training data. The ground truth distance between two aspects aₓ and a_{y}, i.e. d^{G}(aₓ,a_{y}) may be, computed by summing up all the distances of edges along the shortest path between them, where the distance of every edge is assumed to be 1. The optimal weights are then estimated by solving the ridge regression optimization problem below,

arg min_{(ω}_{ⱼ}₎_{₁}_{^{m}}Σ_{x<y;a}_{ₓ}_{,a}_{_{y}}_{∈A}_{⁰}(d^{G}(aₓ,a_{y})−Σⱼ₌₁^{m}ωⱼƒⱼ(aₓ,a_{y}))²+η·Σⱼ₌₁^{m}ωⱼ² (3.10)

where m represents the dimension of linguistic features, and η is a trade-off parameter.

Eq.(3.10) can be re-written to matrix form:

$${arg min}_{w} {‖ d - {f}^{T} w ‖}^{2} + η \cdot {‖ w ‖}^{2} \qquad ( 3.11 )$$

The optimal solution is derived as,

w*₀=(f^{T}f+η·I)⁻¹(f^{T}d) (3.12)

where w*₀ is the optimal weight vector, d denotes the vector of the ground truth distance, f represents the feature function vector, and I is the identity matrix.

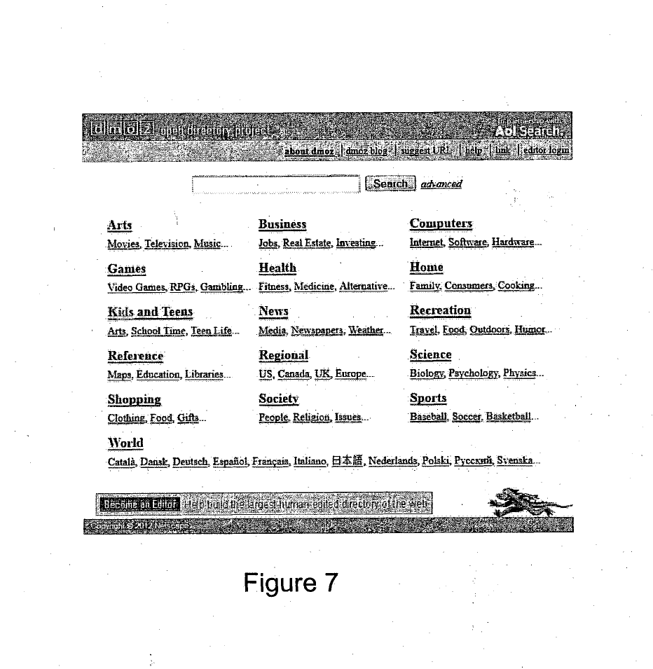

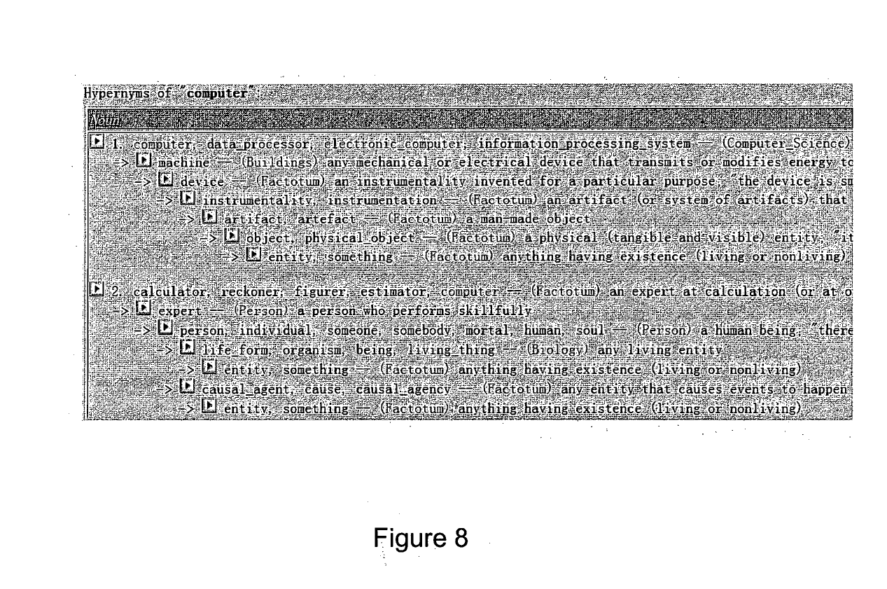

The above learning algorithm can perform well when sufficient training data (i.e. distance of aspect pair) is available. However, the initial hierarchy may be too coarse and thus may not provide sufficient information for training. On the other hand, external linguistic resources (e.g. Open Directory Project (ODP) in FIG. 7 and WordNet in FIG. 8) may provide abundant hand-crafted hierarchies. These resources are therefore leveraged to assist in semantic distance learning. A distance metric w₀ is learned from the parent-child pairs in the external linguistic resources by Eq.(3.12). Since w₀ might be biased to the characteristics of the external linguistic resources, directly using w₀ in our task may not perform well. Alternatively, w₀ can be used as the prior knowledge to help to learn the optimal distance metric w from the initial hierarchy. The learning problem is formulated as follows,

$${arg min}_{w} {‖ d - {f}^{T} w ‖}^{2} + η \cdot {‖ w ‖}^{2} + γ \cdot {‖ w - {w}_{0} ‖}^{2} \qquad ( 3.13 )$$

where d denotes the ground truth distance in the initial hierarchy, ηand γ are the trade-off parameters.

The optimal solution of w can be obtained as

w*=(f^{T}f+(η+γ)·I)⁻¹(f^{T}d+γ·w₀) (3.14)

As a result, the semantic distance d(aₓ,a_{y}) may be computed according to Eq.(3.1).

Sentiment Classification on Product Aspects

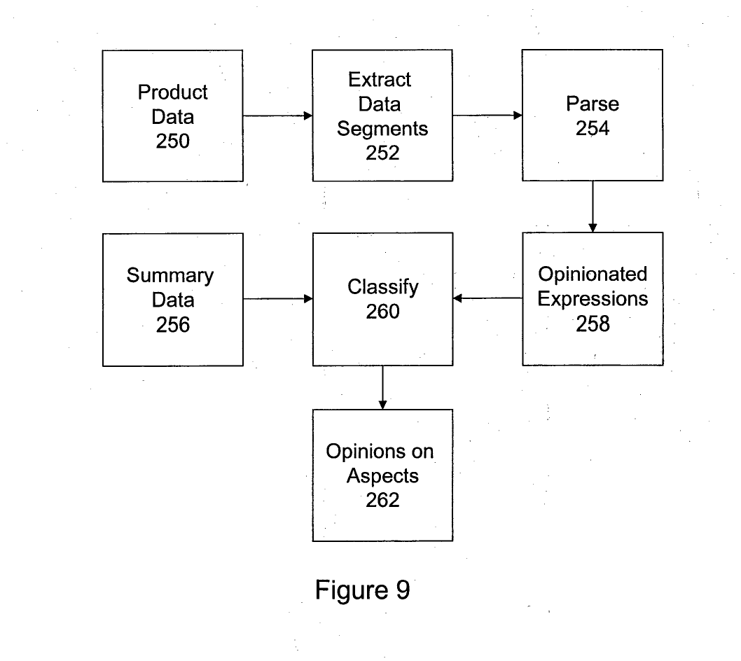

After generating a hierarchy to organize all the newly identified aspects and data (i.e. consumer reviews), sentiment classification may be performed to determine opinions on the corresponding aspects, and obtain the final hierarchical organization. An overview of sentiment classification in accordance with an embodiment is demonstrated in the flow diagram of FIG. 9.

As mentioned above, the summary data, for example, the Pros and Cons reviews explicitly categorize positive and negative opinions on the aspects. These reviews are valuable training samples to teach a sentiment classifier. A sentiment classifier is therefore trained based on the summary data, and the classifier is employed to determine the opinions on aspects in the free text reviews 154.

At 250 consumer reviews are obtained as proposed above. It is to be understood that the consumer reviews represent data relating to a certain product in this embodiment. The data may be obtained from various internet sites. At 252, data segments are extracted from the data obtained in 250. For example, the free text review portion 154 of each consumer review obtained in 250 may be split into sentences. At 254, each data segment (e.g. sentence) may be parsed, for example, using a Stanford parser.

At 256, the sentiment terms in the summary data (e.g. Pros and Cons reviews) are extracted based on a sentiment lexicon. In an embodiment, the sentiment lexicon is the one used in: T. Wilson, J. Wiebe, and P. Hoffmann; Recognizing Contextual Polarity in Phrase-level Sentiment Analysis; conference on Human Language Technology and Empirical Methods in Natural Language Processing (HLT/EMNLP, 2005). These sentiment terms are used as features, and each review is represented as a feature vector. A sentiment classifier is then taught from the summary data (e.g. Pros reviews 160 (i.e., positive samples) and Cons reviews 162 (i.e., negative samples)). The classifier can be SVM, Naïve Bayes and Maximum Entropy model.

In an embodiment, an SVM classifier is trained based on summary data which explicitly provides opinion labels (e.g. positive/negative) for specific product aspects. Sentiment terms in the data are collected as features and each data segment is represented in feature vectors with Boolean weighting.

At 258, given a free text review 154 that may cover multiple aspects, the opinionated expression that modifies a corresponding aspect is located. For example, the expression “well” is located in the review “The battery of Nokia N95 works well.” for the aspect “battery.” Generally, an opinionated expression is associated with the aspect if it contains at least one sentiment term in the sentiment lexicon, and is the closest one to the aspect in the parse tree determined in 254 within a certain context distance, for example, five (5).

At 260, the trained sentiment classifier is then leveraged to determine the opinion of the opinionated expression, i.e. the opinion on the aspect. The product aspect sentiment is then collected at 262. In an embodiment, the method may be performed by a general purpose computer with a display screen, or a specially designed hardware apparatus having a display screen. Accordingly, at 262, the aspect sentiments may be sent to a display screen for display to a human user. In this way, it is possible to obtain opinions on identified product aspects from data relating to the product.

In an embodiment an aspect sentiment for an identified product aspect is determined based on data relating to the product. The aspect sentiment may be thought of as an opinion (e.g. good or bad) on the product aspect. The aspect sentiment is then associated with the identified product aspect in the modified (i.e. finished) hierarchy. In this way, sentiments or opinions on the product aspects mentioned in the hierarchy may be associated with the aspects in the hierarchy. Accordingly, the hierarchy may not only include aspects of a product, but also opinions on each aspect. Therefore, it may be possible to use the hierarchy to come to an informed opinion or conclusion about the product.

In an embodiment, an aspect sentiment is determined in the following manner. One or more aspect opinions (e.g. a segment of data) are extracted from the data. The or each aspect opinion identifies the identified product aspect and a corresponding opinion on that aspect. The or each aspect opinion is then classified into one of a plurality of opinion classes based on its corresponding opinion (e.g. using a SVM). Each opinion class is associated with a different opinion. Further, the aspect sentiment for the identified product aspect is determined based on which one of the plurality of opinion classes contains the most aspect opinions. For example, if a majority of the opinions about a product aspect are negative with only a few positive opinions, the overall opinion (i.e. sentiment) on the aspect is negative.

In an embodiment, the plurality of opinion classes includes a positive opinion class being associated with positive opinions (e.g. good, great, wonderful, excellent) and a negative opinion class being associated with negative opinion (e.g. bad, worse, terrible, disappointing).

Evaluations

The following evaluates the effectiveness of the proposed framework in terms of product aspect identification, aspect hierarchy generation, and sentiment classification on aspects. In the following evaluations, ‘our approach’ is to be understood to mean ‘an embodiment’.

Data Set and Experimental Settings

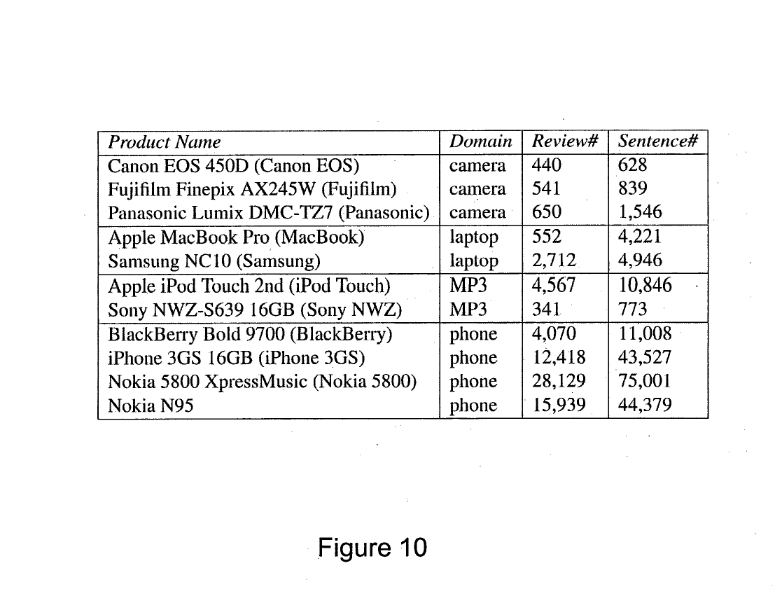

FIG. 10 shows a table of the details of the product review corpus. The dataset contains consumer reviews on 11 popular products in four domains. There are 70,359 reviews in total and around 6,396 reviews for each product on average. These reviews were crawled from multiple prevalent forum websites, including cnet.com, viewpoints.com, reevoo.com, gsmarena.com and pricegrabber.com. The reviews were posted between June 2009 and July 2011. Eight annotators were invited to annotate the ground truth on these reviews. They were asked to annotate the product aspects in each review, and also label consumer opinions expressed on the aspects. Each review was labelled by at least two annotators. The average inter-rater agreement in terms of Kappa statistics is 87% for all the products. In addition, three participants were asked to construct the gold standard hierarchy. For each product, they were provided the initial hierarchy and the aspects commented in the reviews. They were required to build a hierarchy which allocates all the aspects based on the initial hierarchy. In terms of Kappa statistics, the average inter-rater agreement of the parent-child relations among aspects is 73%. The conflicts between participants were resolved through their discussions. For semantic distance learning, 50 hierarchies were collected from WordNet and ODP, respectively, as external linguistic resources.

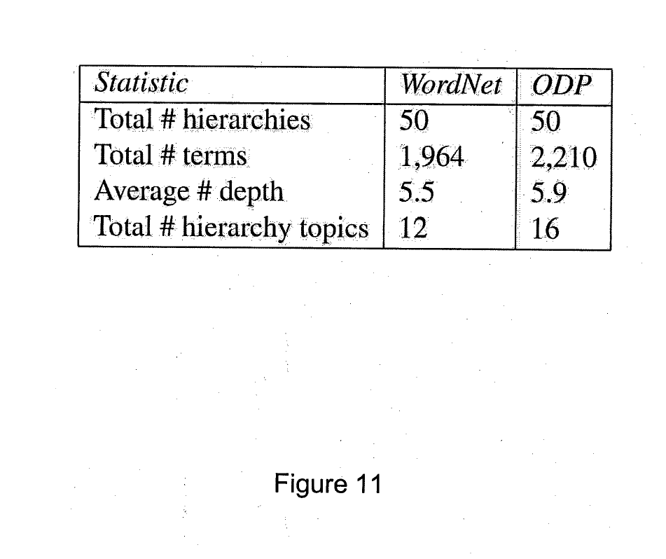

FIG. 11 shows a table of the details on these hierarchies. Specifically, the hypernym and meronym relations were utilized in WordNet to construct 50 hierarchies. Such relations indicate parent-child relations among concepts. Only one word sense was used in WordNet to avoid word sense ambiguity. In addition, the topic lines were parsed in the ODP XML databases to obtain relations, and used to construct another 50 hierarchies.

An F₁-measure was employed as the evaluation metric for all the evaluations. It is the combination of precision and recall, as F₁measure=2*precision*recall/(precision+recall). For the evaluation on aspect hierarchy generation, precision is defined as the percentage of correctly returned parent-child pairs out of the total number of returned pairs, and recall is defined as the percentage of correctly returned parent-child pairs out of the total number of pairs in the gold standard. Throughout the experiments, the parameters were set as follows: λ₁=0.4, λ₂=0.3, λ₃=0.3, η=0.4 and γ=0.6.

Evaluations on Product Aspect Identification of Free Text Reviews

In this experiment, the following approaches for aspect identification were implemented:
The method proposed by Hu et al. in: M. Hu and B. Liu; Mining and Summarizing Customer Reviews; 10th ACM SIGKDD international conference on Knowledge Discovery and Data mining (SIGKDD, 2004), which extracts noun terms as aspect candidates, and identifies the aspects by rules learned from association rule mining.
The method proposed by Wu et al. in: Y. Wu, Q. Zhang, X. Huang, and L. Wu; Phrase Dependency Parsing for Opinion Mining; 47th Annual Meeting of the Association for Computational Linguistics on Computational Linguistics (ACL, 2009), which extracts noun phrases from a dependency parse tree as aspect candidates, and identifies the aspects by a language model built on the product reviews.

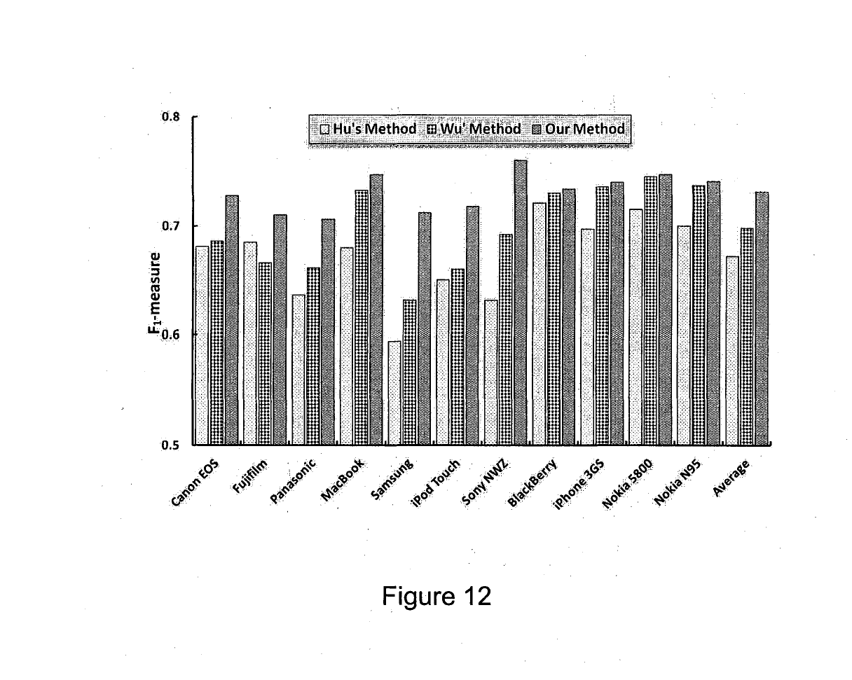

FIG. 12 shows the performance comparison on all the 11 products in terms of F₁-measure. The results are tested for statistical significance by using T-Test as the evaluation metric, where the significance level in the test is set to 0.05, i.e. p-values<0.05. From these results, it is possible to see that our approach get the best performance on all the 11 products. It significantly outperforms Hu's and Wu's methods by over 8.84%, 4.77% respectively in terms of average F₁-measure. This indicates the effectiveness of Pros and Cons reviews in assisting aspect identification on free text reviews. Hence, by exploiting the Pros and Cons reviews, our approach can boost the performance of aspect identification.

Evaluations on Generation of Aspect Hierarchy

Our approach was compared against the state-of-the-art methods, then the effectiveness of the components in our approach were evaluated.

Comparisons to the State-of-the-Art Methods

Four traditional methods in ontology learning for hierarchy generation are utilized for comparison.
Pattern-based method described in: M.-A. Hearst; Automatic Acquisition of Hyponyms from Large Text Corpora; 14th International Conference on Computational Linguistics (COLING, 1992), which explores the pre-defined patterns to identify parent-child relations and forms the hierarchy correspondingly.
Clustering-based method described in: B. Shi and K. Chang; Generating a Concept Hierarchy for Sentiment Analysis; IEEE International Conference on Systems Man and Cybernetics 2008, which builds the hierarchy by hierarchical clustering.
The method proposed by Snow et al. described in: R. Snow and D. Jurafsky; Semantic Taxonomy Induction from Heterogenous Evidence; 44th Annual Meeting of the Association for Computational Linguistics on Computational Linguistics (ACL, 2006), which generates the hierarchy based on a probabilistic model.
The method proposed by Yang et al. described in: H. Yang and J. Callan; A Metric-based Framework for Automatic Taxonomy Induction; 47th Annual. Meeting of the Association for Computational Linguistics on Computational Linguistics (ACL, 2009), which defines multiple metric for the hierarchy generation.

Since our approach and Yang's method can utilize the initial hierarchy to assist in hierarchy generation, their performance was evaluated with or without initial hierarchy, respectively. For the sake of fair comparison, Snow's, Yang's and our approach's methods used the same linguistic features.

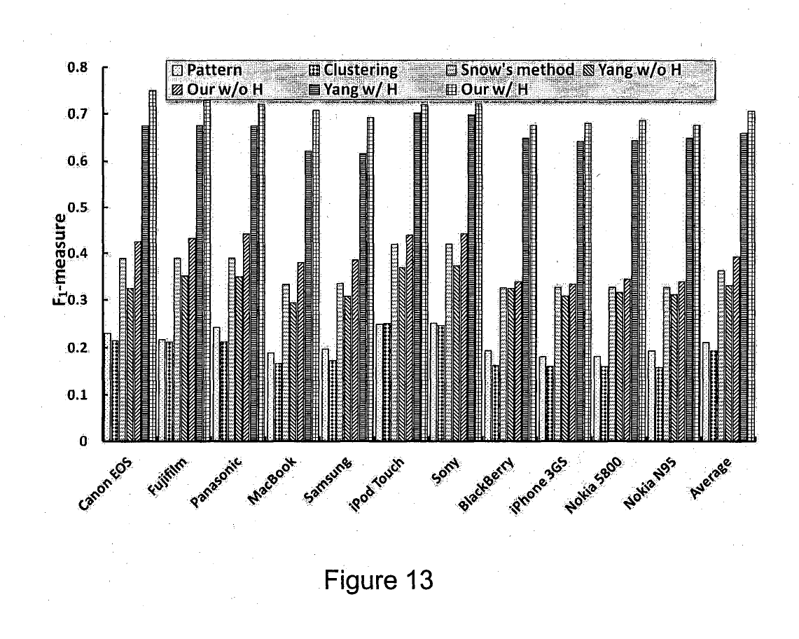

As shown in FIG. 13, without the initial hierarchy, our approach outperforms the pattern-based, clustering-based, Snow's, and Yang's methods by the significant absolute gains of over 17.9%, 19.8%, 2.9%, and 6.1%, respectively in terms of average F₁-measure. As before, the results are tested for statistical significance using T-Test, with p-values<0.05. By exploiting initial hierarchy, our approach improves the performance significantly. As compared to the pattern-based, clustering-based and Snow's methods, our approach improves the average performance by the significant absolute gains of over 49.4%, 51.2% and 34.3%, respectively. Compared to Yang's method with initial hierarchy, it achieves a significant absolute gain of 4.7% in terms of average F₁-measure.

The results show that pattern-based and clustering-based methods perform poorly. Specifically, pattern-based method achieves low recall; while clustering-based method obtains both low precision and recall. A probable reason is that pattern-based method may suffer from the problem of low coverage of patterns, especially when the patterns are pre-defined and may not include all the ones in the reviews. Respectively, the clustering-based method is limited to the use of bisection clustering mechanism which only generates a binary-tree. In addition, the results indicate that the methods using heterogeneous features (i.e. Snow's, Yang's and Our) achieve high F₁-measure. We can speculate that the distinguishability of the parent-child relations among aspects would be enhanced by integrating multiple features. The results also indicate that the methods with initial hierarchy (i.e. Yang's and Our) can significantly boost the performance. Such results further convince us that the initial hierarchy is valuable for hierarchy generation. Finally, the results show that our approach outperforms Yang's method when both utilize the initial hierarchy. A probable reason is that our approach is able to derive reliable semantic distances among aspects by exploiting the external linguistic resources to assist distance learning, thereby improving the performance.

Evaluations on the Effectiveness of the Initial Hierarchy

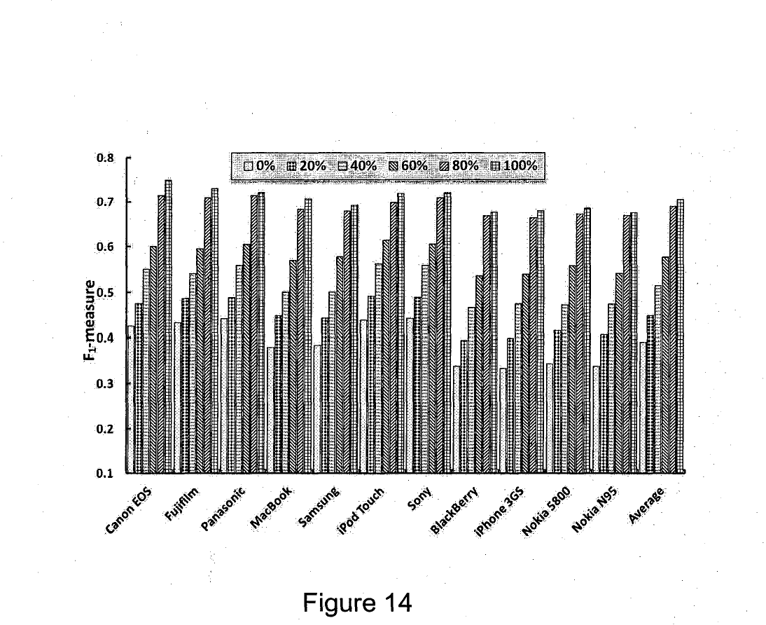

The following shows that by using different proportions of the initial hierarchy, the proposed approach can still generate a satisfactory hierarchy. Different proportions of the initial hierarchy were explored, including 0%, 20%, 40%, 60%, 80%, and 100% of the aspect pairs which were collected top-to-down, left-to-right. As shown in FIG. 14, the performance increases when a larger proportion of the initial hierarchy is used. Thus, this suggests that the domain knowledge is valuable in the aspect hierarchy generation. As before, the results are tested for statistical significance using T-Test, with p-values<0.05.

Evaluations on the Effectiveness of Optimization Criteria

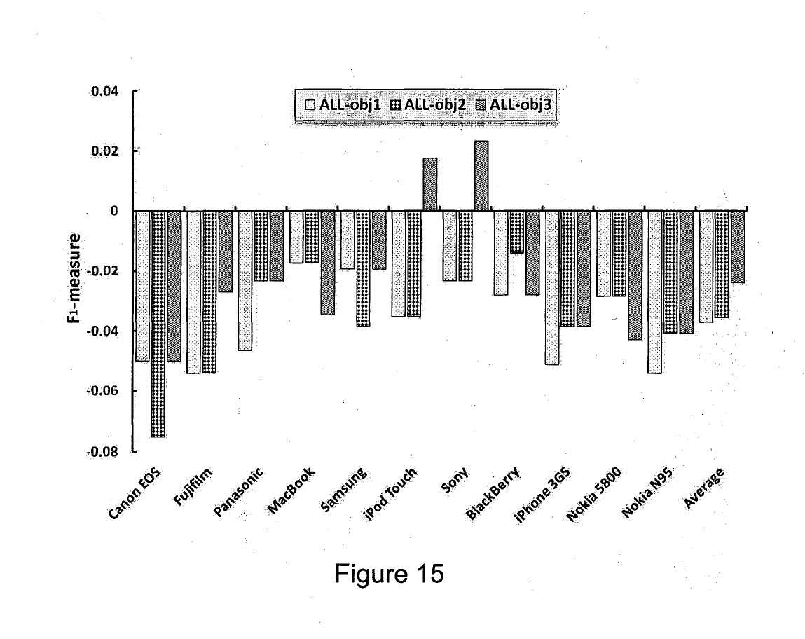

A leave-one-out study is conducted to evaluate the effectiveness of each optimization criterion. In particular, one of the trade-off parameters (λ₁, λ₂, λ₃) in Eq.(3.9) is set to zero, and its weight to the rest of parameters is distributed proportionally. As illustrated in FIG. 15, removing any optimization criterion degrades the performance on most products. It is interesting to note that removing the third optimization criterion, i.e., minimum semantic inconsistency, slightly increases the performance on two products (iPad touch and Sony MP3). The reason might be that the values of the three trade-off parameters (empirically set above) are not suitable for these two products. As before, the results are tested for statistical significance using T-Test, with p-values<0.05.

Evaluations on Semantic Distance Learning

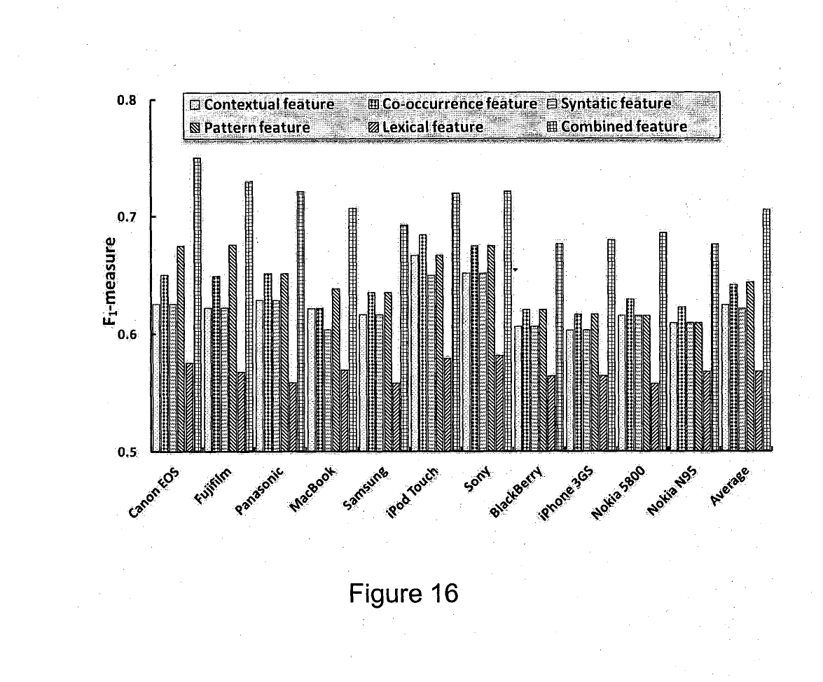

This section involves evaluation of the impact of the linguistic features and external linguistic resources for semantic distance learning. Five sets of features as described above were investigated, including contextual, co-occurrence, syntactic, pattern and lexical features. As shown in FIG. 16, co-occurrence and pattern features outperform contextual and syntactic features. This demonstrates that co-occurrence and pattern features are effective to indicate the parent-child relations among aspects. Among these features, the lexical features perform the worst. It is noted that the combination of all the features achieves the best performance. On average, the combined features outperform contextual features, co-occurrence features, syntactic features, pattern features, and lexical features by over 13.1%, 10.0%, 13.6%, 9.7%, and 24.3%, respectively in terms of average F₁-measure. These results indicate that the heterogeneous features would be complementary and can assist to derive the semantic distance more accurately. As before, the results are tested for statistical significance using T-Test, with p-values<0.05.

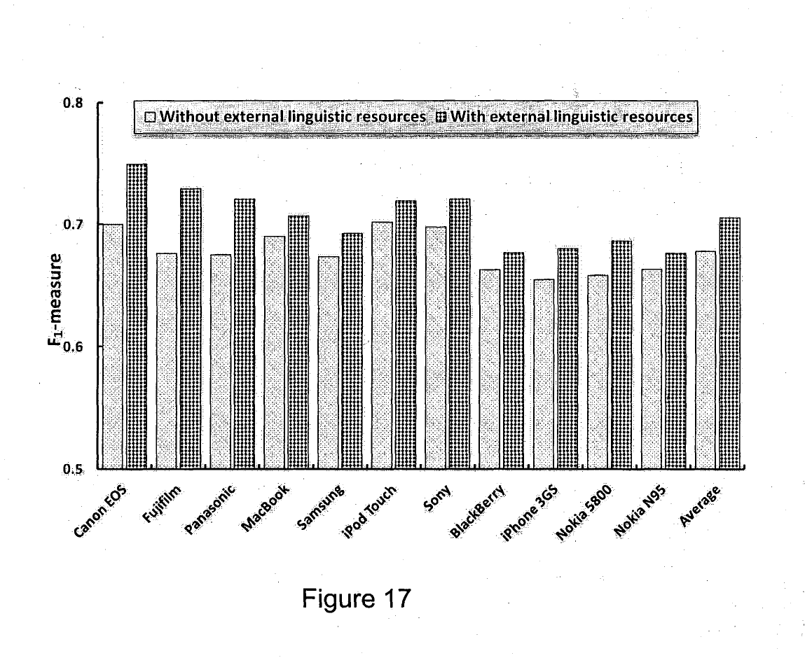

Next, the effectiveness of using external linguistic resources (e.g. WordNet and ODP) is examined on semantic distance learning. Our approach with or without external linguistic resources was examined. As illustrated in FIG. 17, by exploiting external linguistic resources, our approach significantly outperforms the method without external resources by over 4.2% in terms of average F₁-measure. This suggests that external linguistic resources can help us obtain accurate semantic distance, which boosts the performance of aspect hierarchy generation. As before, the results are tested for statistical significance using T-Test, with p-values<0.05.

Evaluations on Aspect-Level Sentiment Classification

In this experiment, the following sentiment classification methods were compared:
An unsupervised method. It is a dictionary-based method. The opinion on each aspect is determined by referring to the sentiment lexicon SentiWordNet from B. Ohana and B. Tierney; Sentiment Classification of Reviews using Sentiwordnet; 9th IT&T Conference 2009. The lexicon contains a list of positive/negative words. The opinionated expression associated with the aspect is classified as positive (or negative) if it contains a majority of words in the positive (or negative) list.
Three supervised methods. The following three supervised methods were employed: the method proposed by Pang et al. in: B. Pang, L. Lee, and S. Vaithyanathan; Thumbs up? Sentiment Classification using Machine Learning Techniques; conference on Empirical Methods on Natural Language Processing (EMNLP, 2002), including Naïve Bayes (NB), Maximum Entropy (ME), and Support Vector Machine (SVM). These classifiers were trained on Pros and Cons reviews as described above. In particular, SVM was implemented by using IibSVM from: C.-C. Chang and C. Lin; Libsvm: a Library for Support Vector Machines, with linear kernel, NB was implemented with Laplace smoothing, and ME was implemented with L-BFGS parameter estimation.

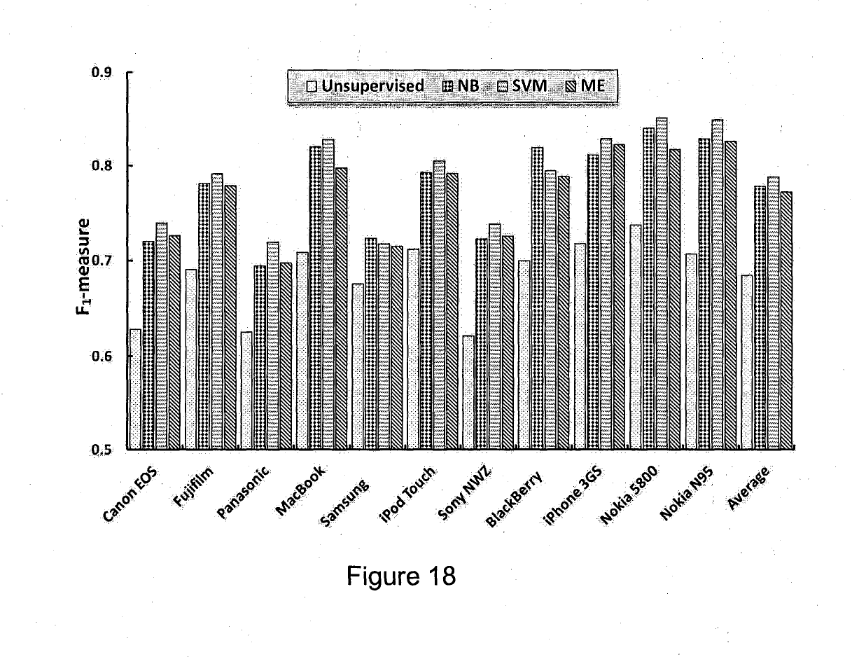

FIG. 18 shows the experimental results. It can be seen that the three supervised methods perform much better than the unsupervised approach. As before, the results are tested for statistical significance using T-Test, with p-values<0.05. They achieve performance improvements on all the 11 products. In particular, SVM performs the best on 9 products, NB obtains the best performance on the remaining two products. In terms of average performance, SVM achieves slight improvements compared to NB and ME. These results are consistent with the previous research from B. Pang, L. Lee, and S. Vaithyanathan; Thumbs up? Sentiment Classification using Machine Learning Techniques; conference on Empirical Methods on Natural Language Processing (EMNLP, 2002).

Sub-Tasks Reinforced by the Hierarchy

The following shows that the generated (i.e. modified) hierarchy can reinforce the sub-tasks of product aspect identification and sentiment classification on aspects in accordance with various embodiments.

Product Aspect Identification with the Hierarchy

As aforementioned, in an embodiment, product aspect identification aims to recognize product aspects commented in data relating to the product (e.g. consumer reviews). Generally, its performance would be affected by three main challenges. First, aspects are often identified as the noun phrases in the reviews. However, noun phrases would contain noises that are not aspects. For example, in the review “My wife and her friends all recommend the battery in Nokia N95.” noun phrases “wife” and “friends” are not aspects. Second, some “implicit” aspects do not explicitly appear in the reviews but are actually commented in them. For example, the review “The iPhone 4 is quite expensive.” reveals negative opinion on the aspect “price”, but “price” does not appear in the review. These implicit aspects may not be effectively identified by the methods which rely on the appearance of aspect terms. Third, some aspects may not be effectively identified without considering the parent-child relations among aspects. For example, the review “The battery of the camera lasts quite long.” conveys positive opinion on the aspect “battery” while the noun term “camera” is served as the modified term. Parent-child relations are needed to accurately identify the aspect “battery” from the reviews.

One simple solution for these challenges can resort to the review hierarchy. As mentioned above, the hierarchy organizes product aspects as nodes, following their parent-child relations. For each aspect, the reviews and corresponding opinions on this aspect are stored. Such a hierarchy can facilitate product aspect identification. Specifically, the noise noun phrases can be filtered by making use of the hierarchy. For the implicit aspects, they are usually modified by some peculiar sentiment terms. For example, the aspect “size” is often modified by the sentiment terms such as “large”, but seldom by the terms such as “expensive.” In other words, there are some associations between the aspects and sentiment terms. Thereby implicit aspects can be inferred by discovering the underlying associations between the sentiment terms and aspects in the hierarchy. Moreover, by following the parent-child relations in the hierarchy, the true aspects can be directly acquired. These observations lead to using the generated (i.e. modified) hierarchy to reinforce the task of product aspect identification.

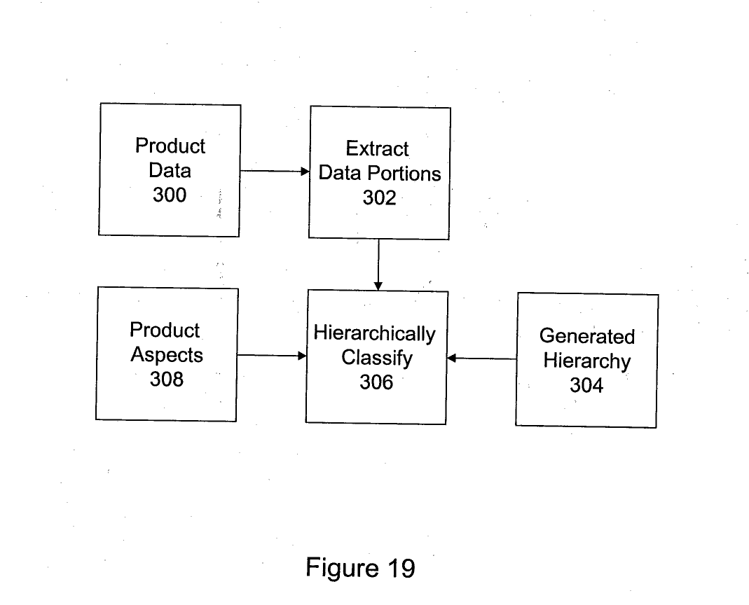

In an embodiment, in order to simultaneously identify explicit/implicit aspects, a hierarchical classification technique is adopted by leveraging the generated hierarchy. Such technique takes into account the aspects and parent-child relations among aspects in the hierarchy. Also, it discovers the associations between aspects and sentiment terms by multiple classifiers. FIG. 19 illustrates a flowchart of the approach in accordance with an embodiment. The following describes FIG. 19 in detail.

At 300, data relating to a certain product is obtained. For example, the data may comprise consumer reviews of the product. These may be obtained, for example, from the internet. As discussed in more detail below, the data may comprise first and second data portions. At 302, data segments are extracted from the data obtained in 300. For example, the free text review portion 154 of each consumer review obtained in 300 may be split into sentences.

In an embodiment, a data portion consists of multiple different consumer reviews, whereas a data segment consists of a sentence from a single consumer review. Therefore, in an embodiment, a data portion may be larger than a data segment.

At 304, a generated hierarchy is obtained in accordance with the above description. This hierarchy may be obtained using different data relating to the product. For example, a set of training data (i.e. second data portion) may be used to generate the hierarchy, whereas a set of testing data (i.e. first data portion) may be used above in the extraction of data segments. Both the first and second data sets may comprise reviews of the product.

At 306, the data segments (e.g. sentences) extracted in 302 are hierarchically classified into the appropriate aspect node of the hierarchy obtained in 304, i.e. identify aspects for the data segments. For example, the classification may greedily search a path in the hierarchy from top to bottom, or root to leaf. In particular, the search may begin at the root node, and stop at the leaf node or a specific node where a relevance score is lower than a learned (i.e. predetermined) threshold. The relevance score on each node may be determined by a SVM classifier implementation with a linear kernel. Multiple SVM classifiers may be trained on the hierarchy, e.g. one distinct classifier for each node in the hierarchy. The reviews that are stored in the node and its child-nodes may be used as training samples for the classifier. The features of noun terms, and sentiment terms that are in the sentiment lexicon may be employed. The results of the hierarchical classification identify product aspects in the consumer reviews at 308.

In an embodiment, the method may be performed by a general purpose computer with a display screen, or a specially designed hardware apparatus having a display screen. Accordingly, at 308, the identified aspects may be sent to a display screen for display to a human user.

In the above-described technique, the predetermined threshold may be taught for each distinct classifier (i.e. each node's classifier) by a Perceptron corrective learning strategy. More specifically, for each training sample r on aspect node i, the strategy computes its predicted label as ŷ_{i,r}, with relevance score p_{i,r}. When the predicted label ŷ_{i,r} is inconsistent with the gold standard label g_{i,r}, or the relevance score p_{i,r} is smaller than the current threshold θᵢ^{t}, the threshold is updated as follows,

θᵢ^{t+1}=θᵢ^{t}+ε(ŷ_{i,r}−g_{i,r}) (3.15)

where ε is a corrective constant. For example, this constant may be empirically set to 0.001.

Various embodiments provide a method for identifying product aspects based on data relating to the product. The method comprises the following. A data segment is identified from a first portion of the data A modified hierarchy is generated based on a second portion of the data, as described above. The data segment is then classified into one of a plurality of aspect classes to identify to which product aspect the data segment relates. Each aspect class is associated with a product aspect associated with (i.e. represented by) a different node in the modified hierarchy. For example, the hierarchy may include five nodes, each node representing a different one of five aspects relating to the product. In this case, five aspect classes would be present, a different aspect class for each of the five aspects.

In an embodiment, the step of classifying includes determining a relevance score for each aspect class. The relevance score indicates how similar the data segment is to the product aspect associated with the aspect class. In an embodiment, identifying to which product aspect the data segment relates comprises determining the aspect class associated with a relevance score that is lower than a predefined threshold value. In this way, the classification of an aspect may be more than a simple comparison between known aspects and an extracted term. Stated differently, the system may learn how to identify an aspect even if it is written in a new form.

Evaluations were conducted on the above-described product review dataset. A five fold cross validation was employed, with one fold for testing, and other folds for generating the hierarchy. An F₁-measure was used as the evaluation metric. Our method (i.e. our approach) was compared against the following two methods:
Noun-based method (NounFilter) proposed above. It extracts the frequent noun phrases as aspect candidates, then refines the candidates to obtain true aspects by leveraging a one-class SVM trained on Pros and Cons reviews.
Hierarchy-based method with flat classification technique (HierFlat). This method leverages the hierarchy to identify product aspects. Different from our approach, it treats each aspect in the hierarchy as an individual category without considering the parent-child relations among aspects. Given a testing review, it identifies its product aspects by classifying it into an aspect category using a multi-class SVM classifier. The reviews that are stored in the aspect nodes are used as training samples, with noun phrases and sentiment terms as the features.

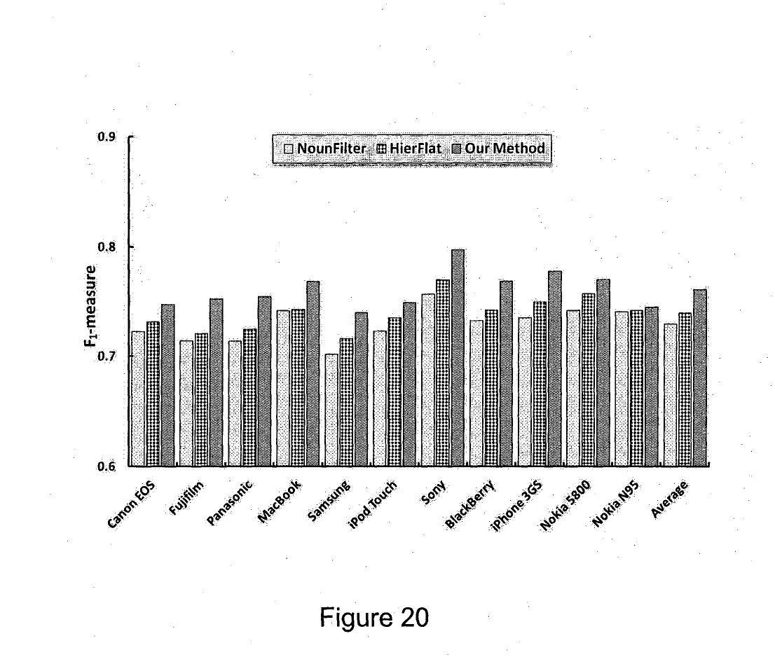

As shown in FIG. 20, the proposed approach significantly outperforms the methods of NounFilter and HierFlat by over 4.4% and 2.9%, respectively in terms of average F₁-measure. These results indicate that the hierarchy helps to filter the noise to obtain accurate aspects. Also, the hierarchical classification technique is effective to identify the true aspects by leveraging the parent-child relations among aspects. The results are tested for statistical significance using T-Test, with p-values<0.05.

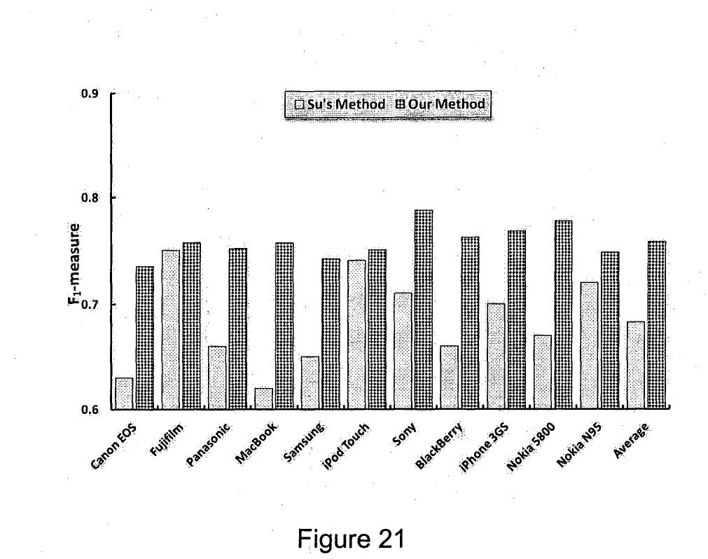

Moreover, the effectiveness of our approach was evaluated on implicit aspect identification. The 29,657 implicit aspect reviews in the product review dataset were used. Our approach was compared against the method proposed by Su et al. in: Q. Su, X. Xu, H. Guo, X. Wu, X. Zhang, B. Swen, and Z. Su; Hidden Sentiment Association in Chinese Web Opinion Mining; 17th international conference on World Wide Web (WWW, 2008), which identifies implicit aspects based on mutual clustering. As shown in FIG. 21, our approach significantly outperforms Su's method by over 10.9% in terms of average F₁-measure. Such results indicate that the hierarchy can help identify implicit aspects by exploiting the underlying associations among sentiment terms and aspects. As before, the results are tested for statistical significance using T-Test, with p-values<0.05.

Sentiment Classification on Aspects Using the Hierarchy

Sentiment classification on the aspect is context sensitive. For example, the same opinionated expression would convey different opinions depending on the context of aspects. For example, the opinionated expression “long” reveals positive opinion on the aspect “battery” in the review “The battery of the camera is long.” while negative opinion on the aspect “start-up time” in the review “The start-up time of the camera is long.” In order to accurately determine the opinions on the aspects, a context sensitive sentiment classifier is used. While the generated hierarchy is shown to help identify the product aspects (i.e. context), it can also be used to directly train the context sensitive classifier. In an embodiment, the hierarchy can thus be leveraged to support aspect-level sentiment classification.

In an embodiment, the idea is to capture the context by identifying the product aspects for each review, and train the sentiment classifier for each aspect by considering the context. Such classifier is context sensitive, which would be helpful to accurately determine the opinions on the aspects. In particular, multiple sentiment classifiers are trained; one classifier for each distinct aspect node in the hierarchy. In an embodiment, each classifier is a SVM. The reviews that are stored in the node and its child-nodes are explored as training samples. Sentiment terms which provided from the sentiment lexicon are employed as the features.

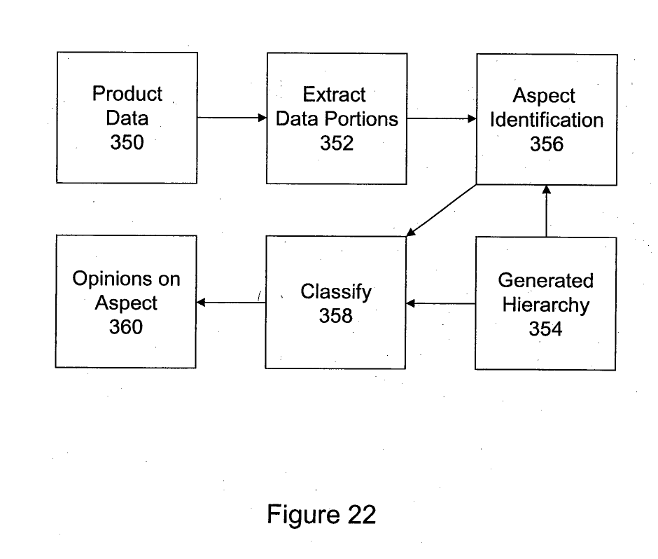

FIG. 22 is a flow diagram of a method for sentiment classification of aspects using the hierarchy in accordance with an embodiment.

At 350, data relating to a certain product is obtained. For example, the data may comprise testing consumer reviews of the product. These may be obtained, for example, from the internet. As mentioned in more detail below, the data may include first and second data portions. At 352, data segments are extracted from the data obtained in 350. For example, the free text review portion 154 of each consumer review obtained in 350 may be split into sentences.

At 354, a generated hierarchy is obtained in accordance with the above description. This hierarchy may be obtained using different data relating to the product. For example, a set of training data (i.e. second data portion) may be used to generate the hierarchy, whereas a set of testing data (i.e. first data portion) may be used above in the extraction of data segments. Both the first and second data sets may comprise reviews of the product. At 356, the hierarchy obtained in 354 is used to identify product aspects as described above with reference to FIG. 19. Also, opinionated expressions for identified products aspects are determined as described above with reference to FIG. 9.

In an embodiment, a data portion consists of multiple different consumer reviews, whereas a data segment consists of a sentence from a single consumer review. Therefore, in an embodiment, a data portion may be larger than a data segment.

At 358, a certain sentiment classifier trained on the corresponding aspect node is selected to determine the opinion in the opinionated expression, i.e. the opinion on the aspect. The sentiment classifier is as described above with reference to FIG. 9. The opinions on various aspects are then collected in 360. In an embodiment, the method may be performed by a general purpose computer with a display screen, or a specially designed hardware apparatus having a display screen. Accordingly, at 360, the opinions may be sent to a display screen for display to a human user.

Various embodiments provide a method for determining an aspect sentiment for a product aspect from data relating to the product. The method includes the following. A data segment is identified from a first portion of the data. A modified hierarchy is generated based on a second portion of the data, as described above. For example, a set of training data (i.e. second data portion) may be used to generate the hierarchy, whereas the data segment may be identified from a set of testing data (i.e. first data portion). Both the first and second data portions may comprise reviews of the product. The data segment is then classified into one of a plurality of aspect classes. Each aspect class is associated with a product aspect associated with a different node in the modified hierarchy. In this way, it is possible to identify to which product aspect the data segment relates. An opinion corresponding to the product aspect to which the data segment relates is then extracted from the data segment. The extracted opinion is then classified into one of a plurality of opinion classes. Each opinion class is associated with a different opinion and the aspect sentiment is the opinion associated with the one opinion class. In this way, it is possible to identify product aspects and then opinion on those product aspects. Also, based on the overriding opinion (e.g. positive, or negative) on a given product aspect, it is possible to determine an overall aspect sentiment (i.e. opinion) on the aspect.

In an embodiment, the plurality of opinion classes includes a positive opinion class being associated with positive opinions (e.g. good, great, wonderful, excellent) and a negative opinion class being associated with negative opinion (e.g. bad, worse, terrible, disappointing).

The proposed method was evaluated using the above-described product review dataset. Five folds cross validation was employed, with one fold for testing and other folds for generating the hierarchy. A F₁-measure was utilized as the evaluation metric. The proposed method was compared against one method which trained an SVM sentiment classifier without considering the aspect context. The SVM was implemented by with a linear kernel.

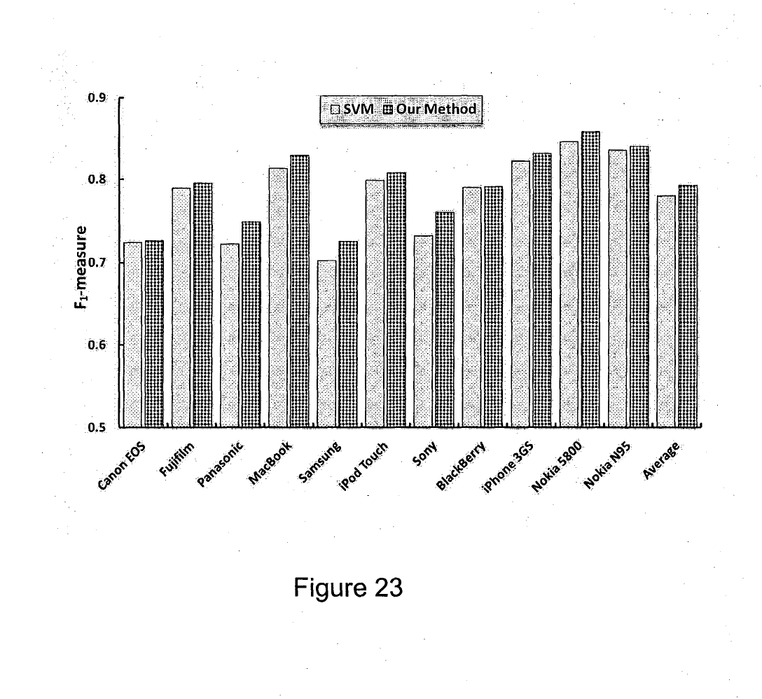

As illustrated in FIG. 23, our method (i.e. our approach) significantly outperforms the traditional SVM method by over 1.6% in terms of average F₁-measure. These results suggest that the generated hierarchy can help to train the context sensitive sentiment classifier, which effectively determines the opinions on aspects.

Summary

According to the above described embodiments, a domain-assisted approach has been described which generates a hierarchical organization of consumer reviews for products. The hierarchy is generated by simultaneously exploiting the domain knowledge and consumer reviews using a multi-criteria optimization framework. The hierarchy organizes product aspects as nodes following their parent-child relations. For each aspect, the reviews and corresponding opinions on this aspect are stored. With the hierarchy, users can easily grasp the overview of consumer reviews, as well as seek consumer reviews and opinions on any specific aspect by navigating through the hierarchy. Advantageously, the hierarchy can improve information dissemination and accessibility.

Evaluations were conducted on 11 different products in four domains. The dataset was crawled from multiple prevalent forum websites, such as CNet.com, Viewpoints.com, Reevoo.com and Pricegrabber.com etc. The experimental results demonstrated the effectiveness of our approach. Furthermore, the hierarchy has been shown to reinforce the sub-tasks of product aspect identification and sentiment classification on aspects. Since the hierarchy organizes all the product aspects and parent-child relations among these aspects, it can be used to help identify the (explicit/implicit) product aspects. While explicit aspects can be identified by referring to the hierarchy, implicit aspects can be inferred based on the associations between sentiment terms and aspects in the hierarchy. The sentiment terms may be discovered from the reviews on corresponding aspects. Moreover, it facilitates aspect-level sentiment classification by training context-sensitive sentiment classifiers with respect to the aspects. Extensive experiments were performed to evaluate the efficacy of these two sub-tasks with the help of hierarchy, and significant performance improvements were achieved.

Product Aspect Ranking Framework

Various embodiments relate to the organization of data relating to a product. In particular, embodiments relate to a method for ranking product aspects, a method for determining a product sentiment, a method for generating a product review summary and to corresponding apparatuses and computer-readable mediums.

The ‘product’ may be any good or item for sale, such as, for example, consumer electronics, food, apparel, vehicle, furniture or the like. More specifically, the product may be a cellular telephone.

The ‘data’ may include any information relating to the product, such as, for example, a specification, a review, a fact sheet, an instruction manual, a product description, an article on the product, etc. The data may include text, graphics, tables or the like, or any combination thereof. The data may refer generally to the product and, more specifically, to individual product aspects (i.e. features). The data may contain opinions (i.e. views) or comments on the products and its product aspects. The opinions may be discrete (e.g. good or bad, or on an integer scale of 1 to 10) or more continuous in nature. The product, opinions and aspects may be derivable from the data as text, graphics, tables or any combination thereof.

A method for identifying important aspects may be to regard the aspects that are frequently commented in the consumer reviews as the important ones. However, consumers' opinions on the frequent aspects may not influence their overall opinions on the product, and thus would not influence their purchase decisions. For example, most consumers frequently criticize the bad “signal connection” of iPhone 4, but they may still give high overall ratings to iPhone 4. In contrast, some aspects such as “design” and “speed,” may not be frequently commented, but usually are more important than “signal connection.” In fact, the frequency-based solution alone may not be able to identify the truly important aspects.

The following embodiment proposes an approach, named aspect ranking, to automatically identify the important product aspects from data. In this embodiment, the data relating to the product comprises consumer reviews. In an embodiment, aspects relating to an example product, iPhone 3GS, may be as illustrated in FIG. 24.

In an embodiment, an assumption is that the important aspects of a product possess the following characteristics: (a) they are frequently commented in the data; and (b) opinions on these aspects greatly influence their overall opinions on the product. It is also assumed that the overall opinion on a product is generated based on a weighted aggregation of the specific opinions on multiple aspects of the product, where the weights essentially measure the degree of importance of the aspects. In addition, a Multivariate Gaussian Distribution may be used to model the uncertainty of the importance weights. A probabilistic regression algorithm may be developed to infer the importance weights by leveraging the aspect frequency and the consistency between the overall and specific opinions. According to the importance weight score, it is possible to identify important product aspects.

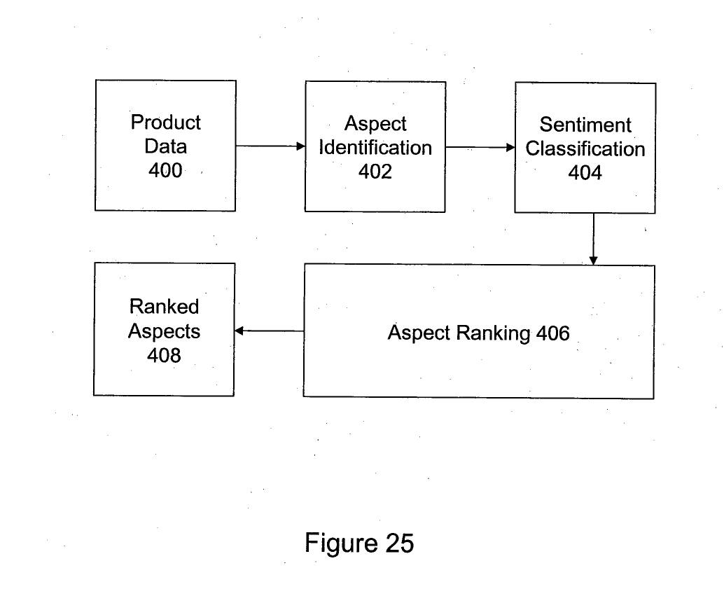

FIG. 25 illustrates an exemplary framework for a method for identifying product aspects in accordance with an embodiment. The following describes this framework in detail.

At 400, data relating to a certain product is obtained. For example, the data may comprise testing consumer reviews of the product. These may be obtained, for example, from the internet. At 402, the obtained data is used to identify product aspects relating to the product. In an embodiment, this process is performed as described above with reference to FIG. 6. At 404, opinions relating to the identified product aspects are identified using the obtained data. In an embodiment, this process is performed as described above with reference to FIG. 9.

In an embodiment, the data relating to the product may be in the form of a hierarchy, such as, the hierarchy obtained in accordance with the method of FIG. 3. In this case, the hierarchy may have been generated as mentioned above on the basis of data relating to the product (i.e. consumer reviews). In this case, the hierarchy can be seen as providing data relating to the product, albeit perhaps in a more organised form compared to the data of 400.

At 406, an aspect ranking algorithm is used to identify the important aspects by simultaneously taking into account aspect frequency and the influence of opinions given to each aspect over the overall opinions on the product (i.e. a measure of influence). The overall opinion on the product may be generated based on a weighted aggregation of the specific opinions on multiple product aspects, where the weights measure the degree of importance (or influence) of these aspects. A probabilistic regression algorithm may be developed to infer the importance weights by incorporating the aspect frequency and the associations between the overall and specific opinions. At 408, ranked aspects are collected. In an embodiment, the method may be performed by a general purpose computer with a display screen, or a specially designed hardware apparatus having a display screen. Accordingly, at 408, the ranked aspects may be sent to a display screen for display to a human user.

Various embodiments provide a method for ranking product aspects based on data relating to the product. The method includes the following. Product aspects are identified from the data. A weighting factor is generated for each identified product aspect based on a frequency of occurrence of the product aspect in the data and a measure of influence of the identified product aspect. The identified product aspects are ranked based on the generated weighting factors. In this way it is possible to determine which product aspects are important together with the importance of each important aspect relative to other important aspects.

In an embodiment, identifying a product aspect from the data includes extracting one or more noun phrases from the data.

In an embodiment, an extracted noun phrase is classified into an aspect class if the extracted noun phrase corresponds with a product aspect associated with the aspect class, the aspect class being associated with one or more different product aspects. In an embodiment, the term ‘correspond’ may include more than just ‘match’. For example, the classification process could identify noun phrases as corresponding to a particular product aspect even if the exact terms of the product aspect are not included in the noun phrase. Classification may be performed using an SVM or some other classifiers. For example, classification may be performed using a one-class SVM. In an embodiment, the aspect class may be associated with multiple (e.g. all) product aspects. In this way, the extracted noun phrase may be either classified or not classified depending on whether or not it is a product aspect. Accordingly true product aspects may be identified from the extracted noun phrases.

In a different embodiment, an extracted noun phrase may be classified into one of a plurality of aspect classes, each aspect class being associated with a different product aspect. In this way, an extracted noun phrase may be identified as being an identified product aspect or not.

In an embodiment, identifying a product aspect from the data is performed as described above with reference to FIG. 19, i.e. using a generated modified hierarchy.

In an embodiment, multiple different extracted noun phrases are clustered together, wherein each of the multiple different extracted noun phrases includes a corresponding synonym term. In this way, different noun phrases which relate to the same product aspect may be combined together. For example, various noun phrases may include the term ‘headphone’, whereas various other noun phrases may include the term ‘earphone’. Since ‘headphone’ and ‘earphone’ relate to the same product aspect, all these noun phrases may be combined together. In this embodiment, ‘headphone’ and ‘earphone’ are corresponding synonym terms. In an embodiment, the step of synonym clustering may be performed after the above-mentioned classifying step.

In an embodiment, an aspect sentiment is determined for an identified product aspect based on the data, and the measure of influence of the identified product aspect is determined using the aspect sentiment. In an embodiment, determining an aspect sentiment includes: (i) extracting one or more aspect opinions from the data, the or each aspect opinion identifying the identified product aspect and a corresponding opinion; (ii) classifying the or each aspect opinion into one of a plurality of opinion classes based on its corresponding opinion, each opinion class being associated with a different opinion; and (iii) determining the aspect sentiment for the identified product aspect based on which one of the plurality of opinion classes contains the most aspect opinions. In an embodiment, determining an aspect sentiment is performed as described above with reference to FIG. 22, i.e. using a generated modified hierarchy. In an embodiment, determining the measure of influence includes extracting a product sentiment for the product from the data, the product sentiment being associated with an opinion; and comparing the aspect sentiment for the identified product aspect and the product sentiment for the product to determine the measure of influence. In an embodiment, the measure of influence may be thought of as a measure of importance, i.e. how important a consumer considers an aspect to be when considering the product as a whole.

In an embodiment, determining the product sentiment includes the following. One or more product opinions (e.g. a segment of data) are extracted from the data, the or each product opinion identifying the product and a corresponding opinion. The or each product opinion is classified into one of a plurality of opinion classes based on its corresponding opinion, each opinion class being associated with a different opinion. The product sentiment for the product is determined based on which one of the plurality of opinion classes contains the most product opinions.

The following describes a method for ranking product aspects based on data relating to the product in more detail in accordance with an embodiment.

Notations and Problem Formulation

In an embodiment, let R={r₁, . . . r_{|R|}} denote a set of consumer reviews of a certain product. In each review r ∈ R , consumer expresses opinions on multiple aspects of a product, and finally assigns an overall rating Oᵣ. Oᵣ is a numerical score that indicates different levels of overall opinion on the review r, i.e. Oᵣ ∈ [Oₘᵢₙ, Oₘₐₓ], where Oₘᵢₙ and Oₘₐₓ are the minimum and maximum ratings respectively. Oᵣ is normalized to [0,1]. Suppose there are m aspects A={a₁, . . . aₘ} in the review corpus R totally, where aₖ is the k-th aspect. Opinion on aspect aₖ in review r is denoted as oᵣₖ. The opinion on each aspect potentially influences the overall rating. It is assumed that the overall rating Oᵣ is generated based on a weighted aggregation of the opinions on specific aspects, as Σₖ₌₁^{m}ωᵣₖoᵣₖ, where each weight ωᵣₖ essentially measures the importance of aspect aₖ in review r. The aim is to reveal the important weights, i.e., the emphasis placed on the aspects, and identify the important aspects correspondingly.

Next, in an embodiment, the product aspect aₖ and consumers' opinions oᵣₖ on various aspects are acquired from the data relating to the product. A probabilistic aspect ranking algorithm is then designed to estimate importance weights {ωᵣₖ}ᵣ₌₁^{|R|} and identify corresponding important aspects.

Aspect Ranking Algorithm

In accordance with an embodiment, the following describes a probabilistic aspect ranking algorithm to identify the important aspects of a product from data relating to the product (e.g. consumer reviews). Generally, important aspects have the following characteristics: (a) they are frequently commented in consumer reviews; and (b) consumers' opinions on these aspects greatly influence their overall opinions on the product. The overall opinion in a review is an aggregation of the opinions given to specific aspects in the review, and various aspects have different contributions in the aggregation. That is, the opinions on (un)important aspects have strong (weak) impacts on the generation of overall opinion. To model such aggregation, the overall rating Oᵣ in each review r is generated based on the weighted sum of the opinions on specific aspects, which is formulated as Σₖ₌₁^{m}ωᵣₖoᵣₖ or in matrix form as ωᵣ^{T}oᵣ. oᵣₖ is the opinion on aspect aₖ and the importance weight ωᵣₖ reflects the emphasis placed on aₖ. Larger ωᵣₖ indicates aₖ is more important, and vice versa. ωᵣ denotes a vector of the weights, and oᵣ is the opinion vector with each dimension indicating the opinion on a particular aspect. Specifically, the observed overall ratings are assumed to be generated from a Gaussian Distribution, with mean ωᵣ^{T}oᵣ and variance σ² as:

$$p ( {O}_{r} ) = \frac{1}{\sqrt{2 {πσ}^{2}}} exp [ - \frac{{( {O}_{r} - {ω}_{r}^{T} {o}_{r} )}^{2}}{2 {σ}^{2}} ] ; \qquad ( 4.1 )$$

In order to take the uncertainty of ωᵣ into consideration, it is assumed that ωᵣ is a sample drawn from a Multivariate Gaussian Distribution as:

$$p ( {ω}_{r} ) = \frac{exp [ - \frac{1}{2} {( {ω}_{r} - μ )}^{T} {Σ}^{- 1} ( {ω}_{r} - μ ) ]}{{( 2 π )}^{m / 2} {det ( Σ )}^{1 / 2}} ; \qquad ( 4.2 )$$

where μ and Σ are the mean vector and covariance matrix, respectively. They may both be unknown and need to be estimated.

As aforementioned, the aspects that are frequently commented by consumers are likely to be important. Hence, aspect frequency is exploited as the prior knowledge to assist learning ωᵣ. In particular, the distribution of ωᵣ, i.e., N(μ, Σ) is expected to be close to the distribution N(μ₀, I). Each element in μ₀ is the frequency of a specific aspect: frequency(aₖ)/Σᵢ₌₁^{m} frequency(aᵢ). Thus, the distribution N(μ, Σ) is formulated based on its Kullback-Leibler (KL) divergence to N(μ₀, I) as

p(μ, Σ)=exp(−φ·KL(N(μ, Σ)∥N(μ₀, I))). (4.3)

where φ is a weighting parameter.

Based on the above formula, the probability of generating overall opinion rating Oᵣ in review r is given as

p(Oᵣ|r)=p(Oᵣ|ωᵣ, μ, Σ, σ²)=∫p(Oᵣ|ωᵣ^{T}oᵣ, σ²)·p(ωᵣ|μ, Σ)·p(μ, Σ)dωᵣ (4.4)

where {ωᵣ}ᵣ₌₁^{|R|} are the importance weights and {μ, Σ, σ²} are the model parameters. While {μ, Σ, σ²} can be estimated from review corpus R={r₁, . . . r_{|R|}} using maximum-likelihood (ML) estimation, ωᵣ in review r can be optimized through maximum a posteriori (MAP) estimation. Since ωᵣ and {μ, Σ, σ²} are coupled with each other, they can be optimized using an expectation maximization (EM)-style algorithm. Iterative optimization of {ωᵣ}ᵣ₌₁^{|R|} and {μ, Σ, σ²} in each E-step and M-step respectively is performed as follows.

Optimizing ωᵣ given {μ, Σ, σ²}:

In an embodiment, suppose the parameters {μ, Σ, σ²} are given, the maximum a posteriori (MAP) estimation is used to get the optimal value of ωᵣ. The object function of MAP estimation for review r is defined as:

L(ωᵣ)=log[p(Oᵣ|ωᵣ^{T}oᵣ, σ²)·p(ωᵣ|μ, Σ)·p(μ, Σ)] (4.5)

By substituting Eq.(4.1)-Eq.(4.3), it is possible to obtain

$$L ( {ω}_{r} ) = - \frac{{( {O}_{r} - {ω}_{r}^{T} {o}_{r} )}^{2}}{2 {σ}^{2}} - \frac{1}{2} {( {ω}_{r} - μ )}^{T} {Σ}^{- 1} ( {ω}_{r} - μ ) - ϕ \cdot KL ( N ( μ , Σ ) \vert \vert N ( {μ}_{0} , I ) ) - log ( σ \cdot {det ( Σ )}^{1 / 2} 2 {π}^{\frac{m + 1}{2}} ) \qquad ( 4.6 )$$

ωᵣ can thus be optimized through MAP estimation as follows:

$$\begin{matrix}{\hat{ω}}_{r} = {arg max}_{{ω}_{r}} L ( {ω}_{r} ) \\ = {arg max}_{{ω}_{r}} \{ - \frac{{( {O}_{r } - {ω}_{r}^{T} {o}_{r} )}^{2}}{2 {σ}^{2}} - \frac{1}{2} {( {ω}_{r} - μ )}^{T} {Σ}^{- 1} ( {ω}_{r} - μ ) \}\end{matrix} \qquad ( 4.7 )$$

The derivative of L(ωᵣ) is taken with respect to ωᵣ and it is let to vanish at the minimiser:

$$\frac{\partial L ( {ω}_{r} )}{\partial {ω}_{r}} = - \frac{( {ω}_{r}^{T} {o}_{r} - {O}_{r} ) {o}_{r}}{{σ}^{2}} - {Σ}^{- 1} ( {ω}_{r} - μ ) = 0 \qquad ( 4.8 )$$

which results in the following solution:

$${\hat{ω}}_{r} = {( \frac{{o}_{r} {o}_{r}^{T}}{{σ}^{2}} + {Σ}^{- 1} )}^{- 1} ( \frac{{O}_{r} {o}_{r}}{{σ}^{2}} + {Σ}^{- 1} μ ) \qquad ( 4.9 )$$

Optimizing {μ, Σ, σ²} given ωᵣ:

In an embodiment, given {ωᵣ}ᵣ₌₁^{|R|}, the parameters {μ, Σ, σ²} are optimized using the maximum-likelihood (ML) estimation over the review corpus R. The parameters are expected to maximize the probability of observing all the overall ratings on the corpus R. Thus, they are estimated by maximizing the log-likelihood function over the whole review corpus R as follows. For the sake of simplicity, {μ, Σ, σ²} is denoted as Φ.

$$\begin{matrix}\hat{Ψ} = {arg max}_{Ψ} L ( R ) \\ = {arg max}_{Ψ} {\sum }_{r ∈ R} log ( p ( {O}_{r} \vert μ , Σ , {σ}^{2} ) )\end{matrix} \qquad ( 4.10 )$$

By substituting Eq.(4.1)-Eq.(4.3), it is possible to obtain

$$\hat{Ψ} = {arg max}_{Ψ} {\sum }_{r ∈ R} \{ - \frac{{( {O}_{r} - {ω}_{r}^{T} {o}_{r} )}^{2}}{2 {σ}^{2}} - \frac{1}{2} {( {ω}_{r } - μ )}^{T} {Σ}^{- 1} ( {ω}_{r} - μ ) - ϕ \cdot KL ( N ( μ , Σ ) \vert \vert N ( {μ}_{0} , I ) ) - log ( σ \cdot {det ( Σ )}^{1 / 2} 2 {π}^{\frac{m + 1}{2}} ) \} \qquad ( 4.11 )$$

The derivative of L(R) is taken with respect to each parameter in {μ, Σ, σ²}, and it is let to vanish at the minimiser:

$$\frac{\partial L ( μ )}{\partial μ} = {\sum }_{r ∈ R}^{ } [ - {Σ}^{- 1} ( {ω}_{r} - μ ) ] - ϕ \cdot I ( {μ}_{0} - μ ) = 0 \\ \frac{\partial L ( Σ )}{\partial Σ} = {\sum }_{r ∈ R} \{ - {( {Σ}^{- 1} )}^{T} - [ - {( {Σ}^{- 1} )}^{T} ( {ω}_{r} - μ ) {( {ω}_{r} - μ )}^{T} {( {Σ}^{- 1} )}^{T} ] \} + ϕ \cdot [ {( {Σ}^{- 1} )}^{T} - I ] = 0 \\ \frac{\partial L ( {σ}^{2} )}{\partial {σ}^{2}} = {\sum }_{r ∈ R} ( - \frac{1}{{σ}^{2}} + \frac{{( {O}_{r} - {ω}_{r}^{T} {o}_{r} )}^{2}}{{σ}^{4}} ) = 0 \qquad ( 4.12 )$$

which leads to the following solutions:

$$\hat{μ} = {( \vert R \vert \cdot {Σ}^{- 1} + ϕ \cdot I )}^{- 1} ( {Σ}^{- 1} {\sum }_{r ∈ R} {ω}_{r} + ϕ \cdot {μ}_{0} ) \\ \hat{Σ} = {\{ {[ {\sum }_{r ∈ R} [ ( {ω}_{r} - μ ) {( {ω}_{r} - μ )}^{T} ] / ϕ + {( \frac{\vert R \vert - ϕ}{2 ϕ} )}^{2} \cdot I ]}^{1 / 2} - \frac{( \vert R \vert - ϕ )}{2 ϕ} \cdot I \}}^{T} \\ {\hat{σ}}^{2} = \frac{1}{\vert R \vert} {\sum }_{r ∈ R} {( {O}_{r} - {ω}_{r}^{T} {o}_{r} )}^{2} \qquad ( 4.13 )$$

In an embodiment, the above two optimization steps are repeated until convergence. As a result, it is possible to obtain the optimal importance weights ωᵣ for each review r ∈ R . For each aspect aₖ, its overall importance score ω̅ₖ is then computed by integrating its importance scores over the reviews as w̅ₖ=(Σ_{r∈R}ωᵣₖ)/|Rₖ|, where Rₖ is the set of reviews containing aₖ. According to ω̅ₖ, the important product aspects can be identified.

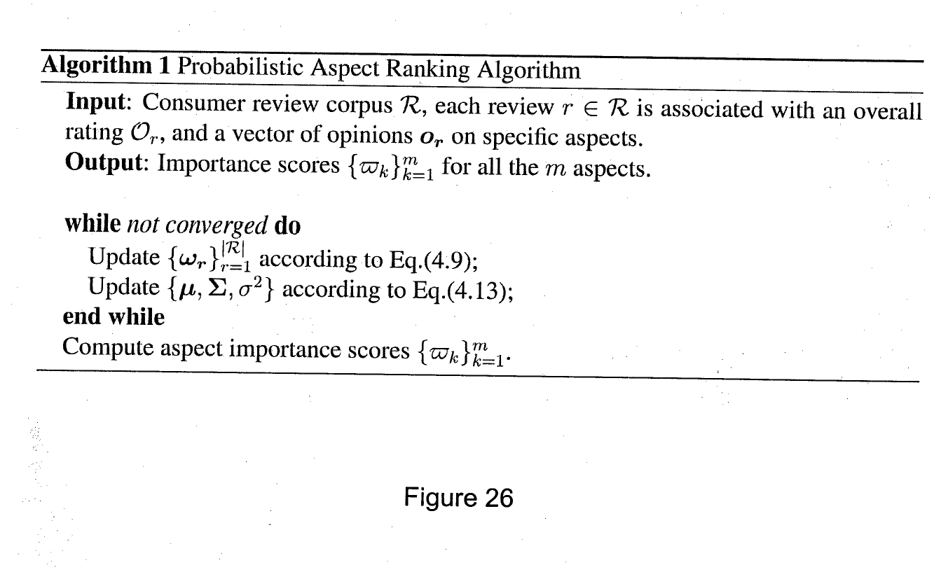

FIG. 26 illustrates the above-described probabilistic aspect ranking algorithm in pseudo-code in accordance with an embodiment.

Evaluations

In this section, extensive experiments are conducted to evaluate the effectiveness of the above proposed framework for product aspect ranking. In the following, it is to be understood that ‘our approach’ and ‘our method’ should be interpreted as ‘an embodiment’.

Data Set and Experimental Settings

The performance of our approach is evaluated using the product review dataset described above. An F₁-measure was used as the evaluation metric for aspect identification and aspect sentiment classification. It is the combination of precision and recall, as F₁-measure=2*precision*recall/(precision+recall). To evaluate the performance of aspect ranking, the widely used Normalized Discounted Cumulative Gain at top-k (NDCG@k) was used as the evaluation metric. Given a ranking list of aspects, NDCG@k is calculated as

$$NDCG @ k = \frac{1}{Z} {\sum }_{i = 1}^{k} \frac{{2}^{t ( i )} - 1}{log ( 1 + i )} \qquad ( 4.14 )$$

where t(i) is the importance degree of the aspect at position i, and Z is a normalization term derived from the top-k aspects of a perfect ranking. For each aspect, its importance degree was judged by three annotators as three importance levels, i.e. “Un-important” (score 1), “Ordinary” (score 2), and “Important” (score 3). Ideally, annotators should be invited to read all the reviews and then give their judgements. However, such labelling process is very time-consuming and labor-intensive. Since NDCG@k is calculated with the importance degrees of the top-k aspects, the labelling process was sped up as follows. First, the top-k aspects were collected from the ranking results of all the evaluated methods. One hundred (100) reviews were then sampled on these aspects, and provided to the annotators for labelling the importance levels of the aspects.

Evaluations on Aspect Ranking

The proposed aspect ranking algorithm was compared against the following three methods.
Frequency-based method, which ranks the aspects according to aspect frequency.
Correlation-based method, which measures the correlation between the opinions on specific aspects and the overall ratings. It ranks the aspects based on the number of cases when two such kinds of opinions are consistent.
Hybrid method, that captures both aspect frequency and the correlation by a linear combination, as λ·Frequency-based Ranking+(1−λ)·Correlation-based Ranking, where λ is set to 0.5 in the experiments

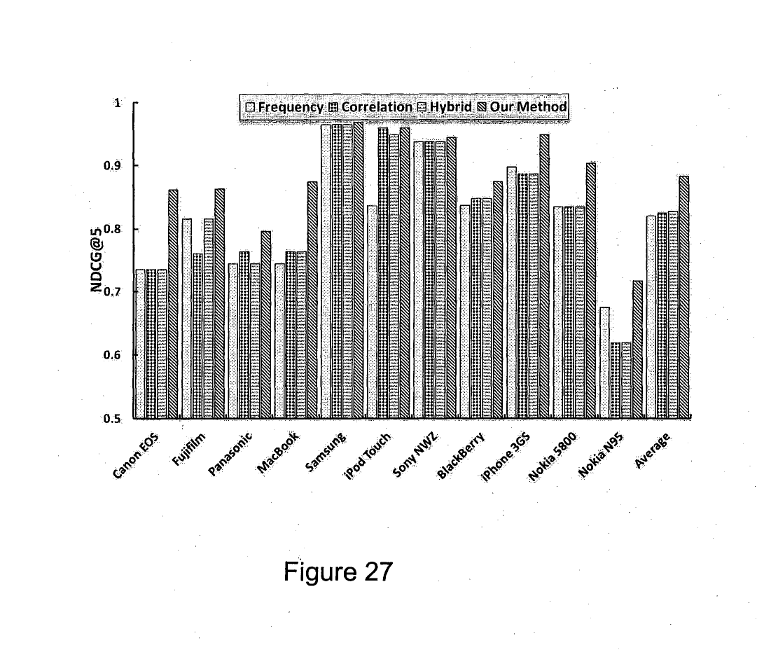

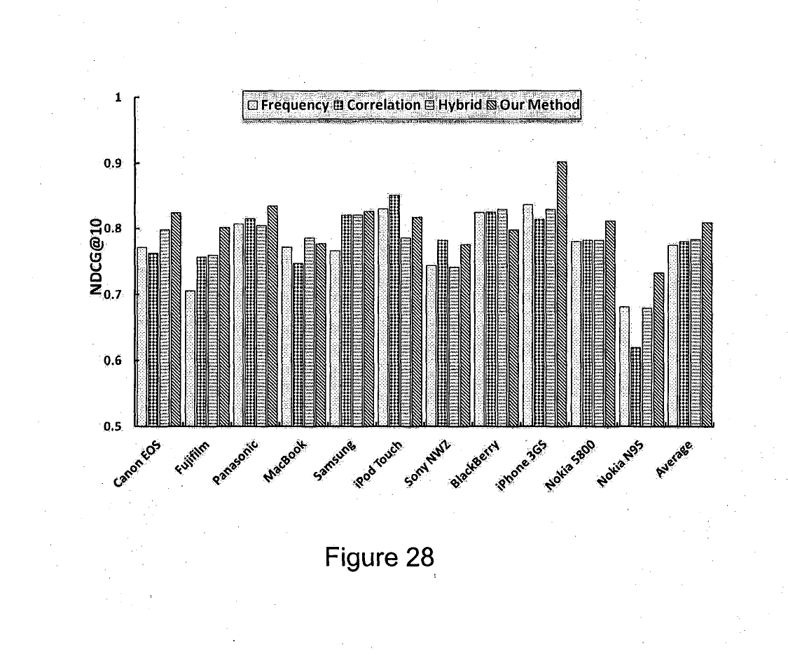

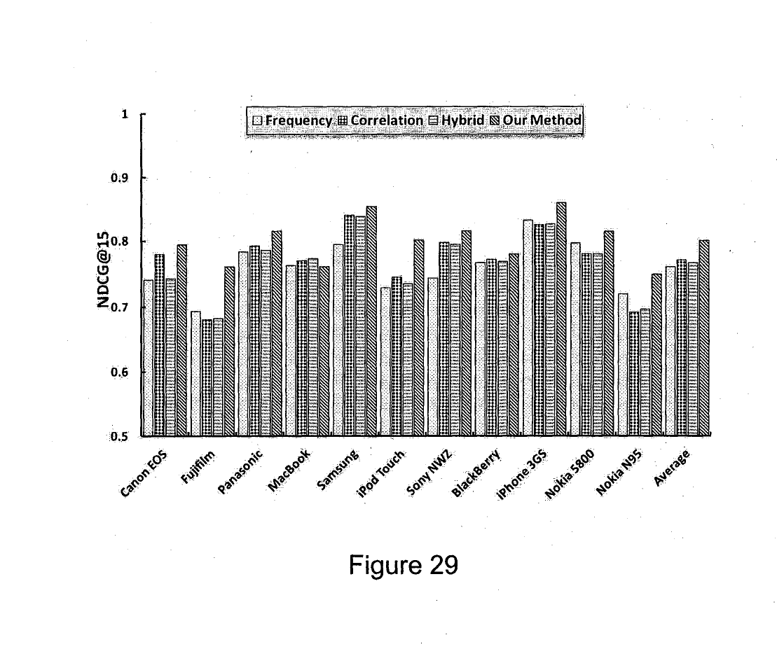

FIGS. 27-29 show the comparison results in terms of NDCG@5, NDCG@10, and NDCG@15, respectively. The results are tested for statistical significance using T-Test, with p-values<0.05. On average, the proposed aspect ranking approach significantly outperforms frequency-based, correlation-based, and hybrid methods in terms of NDCG@5 by over 7.6%, 7.1% and 6.8%, respectively. It improves the performance over these three methods in terms of NDCG@10 by over 4.5%, 3.8% and 3.3%, respectively, while in terms of NDCG@15 by over 5.4%, 3.9% and 4.6%, respectively. Hence, the proposed approach can effectively identify the important aspects from consumer reviews by simultaneously exploiting aspect frequency and the influence of consumers' opinions given to each aspect over their overall opinions. The frequency-based method only captures the aspect frequency information, and neglects to consider the impact of opinions on the specific aspects on the overall ratings. It may recognize some general aspects as important ones. Although the general aspects frequently appear in consumer reviews, they do not greatly influence consumers' overall satisfaction. The correlation-based method ranks the aspects by simply counting the consistent cases between opinions on specific aspects and the overall ratings. It does not model the uncertainty in the generation of overall ratings, and thus cannot achieve satisfactory performance. The hybrid method simply aggregates the results from the frequency-based and correlation-based methods, and cannot boost the performance effectively.

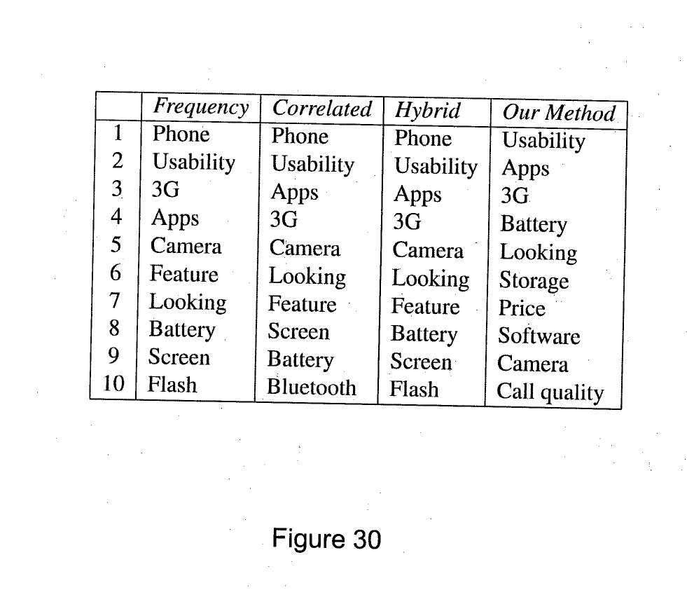

FIG. 30 shows sample results by these four methods. Top 10 aspects of the product iPhone 3GS are listed. From these four ranking lists, it can be seen that the proposed aspect ranking method generates more reasonable ranking than the other methods. For example, the aspect “phone” is ranked at the top by the other methods. However, “phone” is a general but not important aspect.

To better investigate the reasonability of the ranking results of the proposed approach, one public user feedback report is considered, i.e., the “china unicom 100 customers iPhone user feedback report”. This report shows that the top four aspects of iPhone product, which users are most concerned about, are “3G network” (30%), “usability” (30%), “out-looking design” (26%), and “application” (15%). It can be seen that these four aspects are also ranked at the top by our proposed aspect ranking approach.

Tasks Supported by Aspect Ranking

Aspect ranking is beneficial to a wide range of real-world research tasks. In an embodiment, its capacity is investigated in the following two tasks: (i) document-level sentiment classification on review documents, and (ii) extractive review summarization.

Document-Level Sentiment Classification

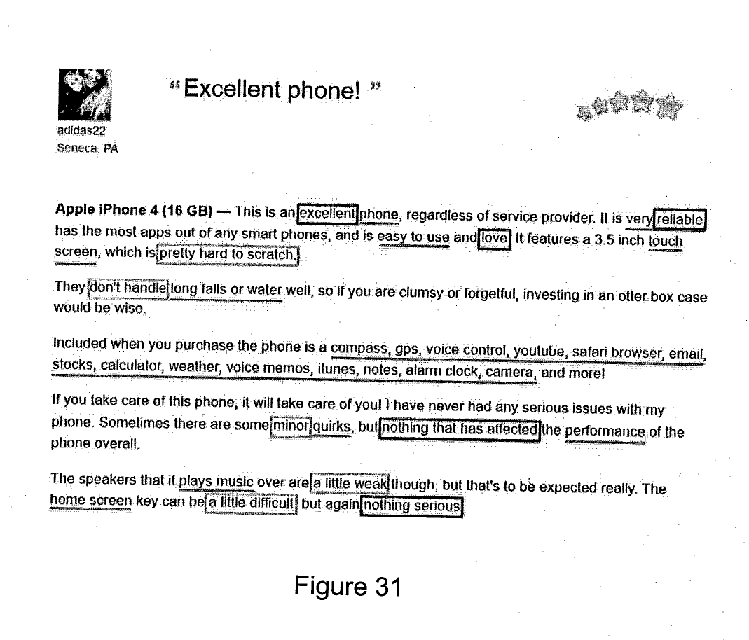

In an embodiment, the goal of document-level sentiment classification is to determine the overall opinion of a given review document (i.e. first data portion). A review document often expresses various opinions on multiple aspects of a certain product. The opinions on different aspects might be in contrast to each other, and have different degree of impacts on the overall opinion of the review document. FIG. 31 illustrates a sample review document for the exemplary product iPhone 4. This review expresses positive opinions on some aspects such as “reliability,” “easy to use,” and simultaneously criticizes some other aspects such as “touch screen,” “quirks,” “music play.” Finally, it is assigned an overall rating of five stars out of five (i.e., a positive opinion) on iPhone 4 due to that the important aspects are related to positive opinions. Hence, identifying important aspects can naturally facilitate the estimation of the overall opinions on review documents. The aspect ranking results can therefore be utilized to assist document-level sentiment classification.

Evaluations were conducted of document-level sentiment classification over the product reviews described above. Specifically, one hundred (100) reviews of each product were randomly selected as testing data (i.e. a second data portion) and the remaining reviews were used for training data (i.e. a first data portion). Each review contains an overall rating, which is normalized to [0,1]. The reviews with high overall rating (>0.5) were treated as positive samples, and those with low rating (<0.5) as negative samples. The reviews with ratings of 0.5 were considered as neutral and not used in the experiments. Noun terms, aspects, and sentiment terms were collected from the training reviews as features. Note that sentiment terms are defined as those appearing in the above-mentioned sentiment lexicon. All the training and testing reviews were then represented into feature vectors. In the representation, more emphasis was given to important aspects, and the sentiment terms modifying them. Technically, the feature dimensions corresponding to aspect a, and its corresponding sentiment terms were weighted by 1+φ· ω̅ₖ, where ω̅ₖ is the importance score of aₖ, and φ is a trade-off parameter and was empirically set to 100 in the experiments. Based on the weighted features, a SVM classifier was taught from the training reviews and used to determine the overall opinions on the testing reviews.

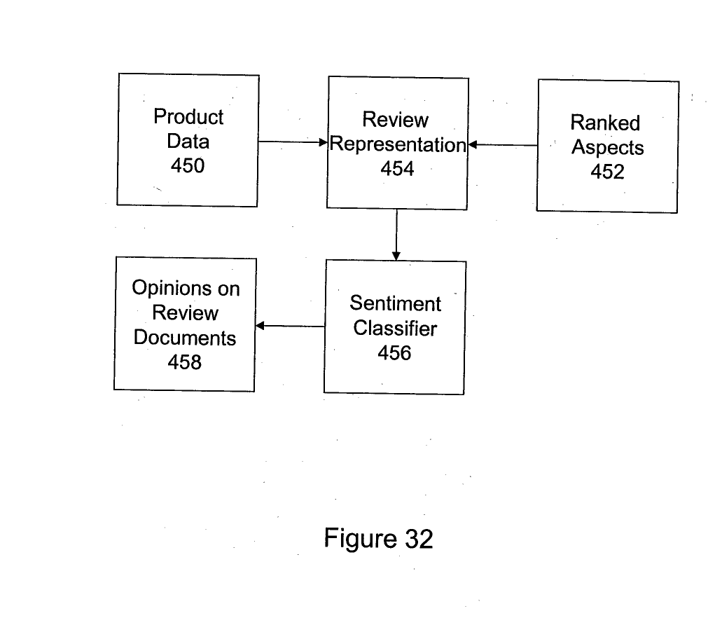

FIG. 32 illustrates a framework for the above-described method for determining a product sentiment from data relating to the product, in accordance with an embodiment.

At 450, data relating to a certain product is obtained. In an embodiment, the data comprises a first data portion (e.g. training data) and a second data portion (e.g. testing data). In an embodiment, both the first and second data portions comprise a plurality of reviews of the same product. The data of the first data portion may be partly or wholly different from the data of the second data portion.

At 452, ranked aspects are generated using the first data portion in accordance with the above-described method, for example, in accordance with the method of FIG. 25.

At 454, each review document in the second data portion is represented into the vector form, where the vectors are weighted by the ranked aspects generated in 452. In an embodiment, features may be defined based on the ranked aspects generated in 452 and, possibly, from an exemplary sentiment lexicon. The features may include noun terms and sentiment terms. Based on the features, each review document can be represented into the vector form, where each vector dimension indicates the presence or absence of a corresponding feature and its associated opinion (i.e. sentiment term) identified from the review document. In an embodiment, each dimension may be weighted in accordance with the rankings of the ranked aspects and the corresponding opinions, i.e. in accordance with their weights. In this manner, greater emphasis may be placed on the data (e.g. features) relating to important aspects and their corresponding opinions.

In summary, therefore, each review document may be represented by a vector. A given vector may indicate the presence or absence of each feature in the associated review document. Also, if a feature is present in the review document, an opinion of the feature given in the review document may be indicated in the vector. In an embodiment, each review document may be represented by a separate vector.

At 456, the overall sentiment (i.e. opinion) of each review document in the second data portion is determined. In an embodiment, this is performed by classifying each feature of a review document into one of a number of opinion classes. Each opinion class is associated with a different opinion. For example, there may be a positive opinion class which is associated with positive opinion. Also, there may be a negative opinion class which is associated with negative opinions. Accordingly, each feature relating to a single review document may be classified as either positive or negative. This process may be performed for each review document in the second data portion.

At 458, the overall opinion of each review document in the second data portion is determined. For example, the overall opinion of a review document may be an aggregation of the opinions for each feature in the review document. In an embodiment, features may be weighted in accordance with their importance based on the rankings. In this way, greater emphasis may be placed on the data (e.g. features) relating to important aspects and their corresponding opinions. Accordingly, a review document may have a better overall opinion by referring to the opinions on the highly ranked aspects than by referring to the less highly ranked aspects. In an embodiment, the method may be performed by a general purpose computer with a display screen, or a specially designed hardware apparatus having a display screen. Accordingly, at 458, the overall opinion may be sent to a display screen for display to a human user.

Various embodiments provide a method for determining a product sentiment from data relating to the product, the product sentiment being associated with an opinion of the product. The data comprises a first data portion and a second data portion. The method includes the following. Ranked product aspects relating to the product are determined based on the first data portion in accordance with the above-described embodiments. One or more features are identified from the second data portion, the or each feature identifying a ranked product aspect and a corresponding opinion. Each feature is classified into one of a plurality of opinion classes based on its corresponding opinion, each opinion class being associated with a different opinion. The product sentiment is determined based on which one of the plurality of opinion classes contains the most features. For example, if an opinion class relating to ‘positive’ opinion contains the greatest number of features, the product sentiment may be ‘positive’.

In an embodiment, the product sentiment is determined based on the aspect rankings corresponding to the features. For example, generating the product sentiment may be a simple calculation of which opinion class contains the most features. However, in another embodiment, the product sentiment may be calculated based on the weights of the aspects such that greater emphasis is placed on opinions relating to highly ranked aspects compared to less highly ranked aspects.

In an embodiment, the plurality of opinion classes includes a positive opinion class being associated with positive opinions (e.g. good, great, wonderful, excellent) and a negative opinion class being associated with negative opinion (e.g. bad, worse, terrible, disappointing).

In an embodiment, the first data portion and the second data portion comprises some of all of the same data, e.g. reviews. In some other embodiments, the data of the first data portion is partly or wholly different from the data of the second data portion.

In an embodiment, the first data portion comprises a plurality of separate reviews of the product and the second data portion comprises a single review of the product.

In an embodiment, the second portion of the data includes a plurality of different reviews of the product, and the method includes the following. Each review in the second portion of the data is represented as a vector.

Each vector indicates the presence or absence of each feature in the associated review. Optionally, each feature is weighted in the vector based on the aspect ranking corresponding to the feature. A product sentiment is determined based on each vector to determine a product sentiment for each review in the second portion of the data. In this way it is possible to obtain an overall opinion on the product based on each review document. In other words, each review document may be summarized as an overall opinion on the product.

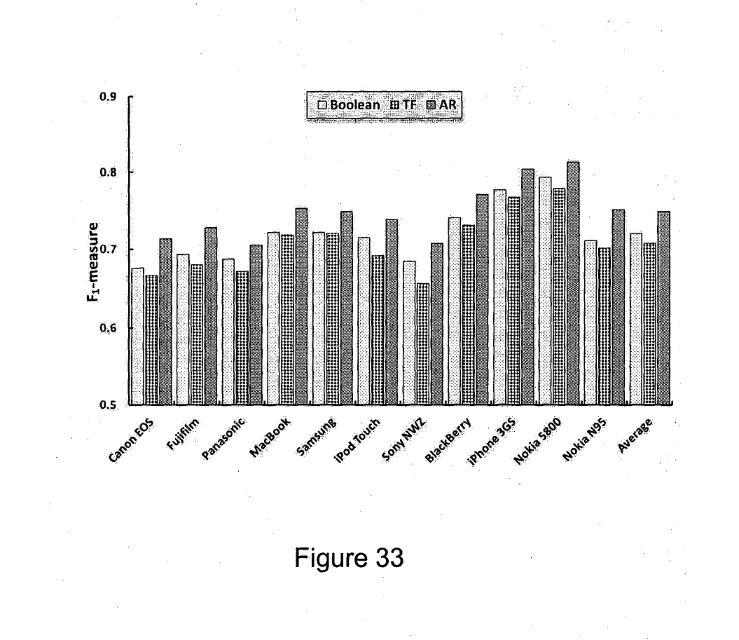

The above approach was compared with two existing methods, i.e., Boolean weighting and term frequency (TF) weighting. Boolean weighting represents each review into a feature vector of Boolean values, each of which indicates the presence or absence of the corresponding feature in the review. Term frequency (TF) weighting weights the Boolean feature by the frequency of each feature on the corpus. FIG. 33 shows the classification performance on the reviews of all the 11 products as well as the average performance over them. Here, our approach is termed as AR since it incorporates Aspect Ranking results into the feature representation. From FIG. 33, it can be seen that our AR weighting approach achieves better performance than the Boolean and TF weighting methods. In particular, it performs the best on all the 11 products, and significantly outperforms the Boolean and TF weighting methods by over 3.9% and 5.8% respectively, in terms of average F₁-measure. It is worthy to note that Boolean weighting is a special case of AR weighting. When all the aspects are set to be equally important, AR weighting degrades to Boolean weighting. From these results, it can be deduced that aspect ranking is helpful in boosting the performance of document-level sentiment classification. In addition, the results also show that Boolean weighting achieves slight performance improvement over TF weighting by about 1.8% in terms of average F₁-measure.

Extractive Review Summarization

As aforementioned, in an embodiment, for a particular product, there may be an abundance of consumer reviews available on the internet. However, the reviews may be disorganized. It is impractical for a user to grasp the overview of consumer reviews and opinions on various aspects of a product from such enormous reviews. On the other hand, the Internet provides more information than is needed. Hence, there is a need for automatic review summarization, which aims to condense the source reviews into a shorter version preserving its information content and overall meaning. Existing review summarization methods can be classified into abstractive and extractive summarization. An abstractive summarization attempts to develop an understanding of the main topics in the source reviews and then express those topics in clear natural language. It uses linguistic techniques to examine and interpret the text. It then finds the new concepts and expressions to best describe the text by generating a new shorter one that conveys the most important information from the original text document. An extractive summarization method consists of selecting important sentences, paragraphs etc. from the original reviews and concatenating them into shorter form.

The following focuses on extractive review summarization in accordance with an embodiment. The following investigates the capacity of aspect ranking in improving the summarization performance.

As introduced above, extractive summarization is formulated by extracting the most informative segments/portions (e.g. sentences or passages) from the source reviews. The most informative content is generally treated as the “most frequent” or the “most favourably positioned” content in existing works. In particular, a scoring function is defined for computing the informativeness of each sentence s as follows:

I(s)=λ₁·Iₐ(s)+λ₂·Iₒ(s), λ₁+λ₂=1 (4.15)

where Iₐ(s) quantifies the informativeness of sentence s in terms of the importance of aspects in s, and Iₒ(s) measures the informativeness in terms of the representativeness of opinions expressed in s. λ₁ and λ₂ are the trade-off parameters. In an embodiment, Iₐ(s) and Iₒ(s) are defined as follows:

Iₐ(s): The sentences containing frequent aspects are regarded as important. Therefore, Iₐ(s) may be defined based on aspect frequency as

Iₐ(s)=Σ_{aspect in s} frequency(aspect) (4.16)

Iₒ(s): The resultant summary is expected to include the opinionated sentences in source reviews, so as to offer a summarization of consumer opinions. Moreover, the summary is desired to include the sentences whose opinions are consistent with consumer's overall opinion. Correspondingly, Iₒ(s) is defined as:

Iₒ(s)=α·Subjective(s)+β·Consistency(s) (4.17)

In an embodiment, Subjective(s) is used to distinguish the opinionated sentences from factual ones, and Consistency(s) measures the consistency between the opinion in sentence s and the overall opinion as follows:

Subjective(s)=Σ_{term in s}|Polarity(term)|

Consistency(s)=−(Overall rating−Polarity(s))² (4.18)

where Polarity(s) is computed as

Polarity(s)=Σ_{term in s} Polarity(term)/(ε+Subjective(s)) (4.19)

where Polarity(term) is the opinion polarity of a particular term and ε is a constant to prevent zero for the denominator.

In an embodiment, with the informativeness of review sentences computed by the above scoring function, the informative sentences can then be selected by the following two approaches: (a) sentence ranking (SR) method ranks the sentences according to their informativeness and select the top ranked sentences to form a summarization; and (b) graph-based (GB) method represents the sentences in a graph, where each node corresponds to a particular sentence and each edge characterizes the relation between two sentences. A random walk is then performed over the graph to discover the most informative sentences. The initial score of each node is defined as its informativeness from the scoring function in Eq.(4.15) and the edge weight is computed as the Cosine similarity between the sentences using unigram as the feature.

As aforementioned, the frequent aspects might not be the important ones and aspect frequency is not capable for characterizing the importance of aspects. It is possible to improve the above scoring function by exploiting the aspect ranking results, which indicate the importance of aspects. In an embodiment, the informativeness of sentence s can be defined in terms of the importance of aspects within it as:

Iₐᵣ(s)=Σ_{aspect in s} importance(aspect) (4.20)

where the importance(aspect) is the importance score obtained by the above described aspect ranking algorithm. The overall informativeness of sentence s is then computed as:

I(s)=λ₁·Iₐᵣ(s)+λ₂Iₒ(s), λ₁+λ₂=1 (4.21)

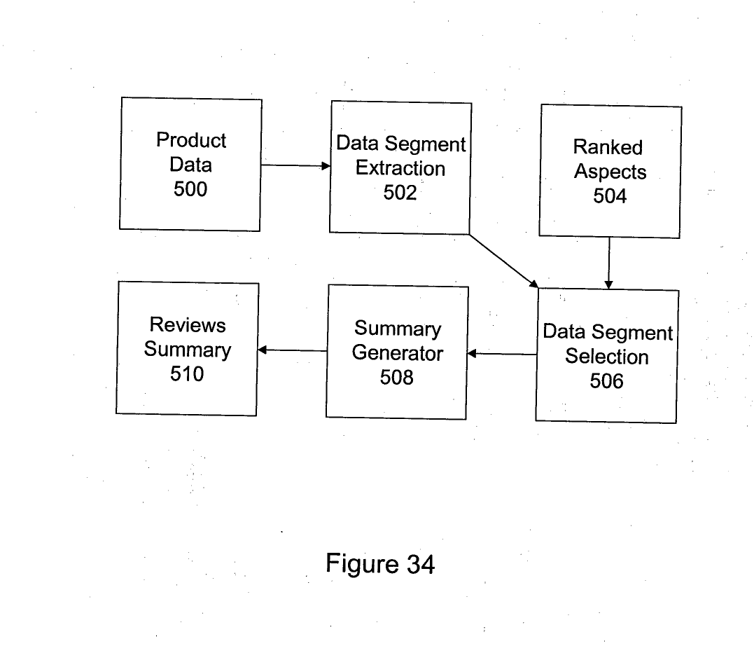

FIG. 34 illustrates an overview of a method for generating a product review summary based on data relating to the product in accordance with an embodiment.

At 500, data relating to a certain product is obtained. The data is split into two portions, a first data portion comprising training data and a second data portion comprising testing data. The data may comprise consumer reviews of the product. These may be obtained, for example, from the internet. At 502, data segments are extracted from the second data portion obtained in 500. For example, a free text review portion of each consumer review of the second data portion may be split into sentences.

At 504, ranked aspects are generated using the first data portion in accordance with the above-described embodiments, for example, in accordance with the method of FIG. 25. At 506, the ranked aspects generated in 504 are used to select certain data segments extracted in 502. In an embodiment, data segments may be selected based on whether they contain ranked aspects and, optionally, the ranking of those ranked aspects. Further, data segments may be selected based on whether they contain opinions on ranked aspects and, optionally, whether those opinions are consistent with the overall opinion on the product.

At 506, the data segments selected in 504 are used to generate a summary for collection at 508. In an embodiment, the method may be performed by a general purpose computer with a display screen, or a specially designed hardware apparatus having a display screen. Accordingly, at 506, the review summary may be send to a display screen for display to a human user.

Various embodiments provide a method, for generating a product review summary based on data relating to the product, the data comprising a first data portion and a second data portion. The method includes the following steps. Ranked product aspects relating to the product are determined based on the first data portion in accordance with the above-described embodiments. One or more data segments are extracted from the second data portion. A relevance score is calculated for the or each extracted data segment based on whether the data segment identifies a ranked product aspect and contains a corresponding opinion. A product review summary comprising one or more of the extracted data segments is generated in dependence on their respective relevance scores. In this way, a summary of the product may be automatically generated based on the data relating to the product.

In an embodiment, the relevance score of an extracted data segment is dependent on the ranking of the ranked product aspect. In an embodiment, the relevance score of an extracted data segment is dependent on whether its corresponding opinion matches an overall opinion of the product.

In an embodiment, the method includes the following. The relevance score for an extracted data segment is compared against a predetermined threshold. The extracted data segment is included in the product review summary in dependence on the comparison. In this manner, only highly relevant information is included in the summary.

An evaluation was conducted on the above-mentioned product review corpus to investigate the effectiveness of the above approach. On hundred (100) reviews of each product were randomly sample as testing samples (i.e. a second data portion). The remaining reviews were used to teach the aspect ranking results, i.e. the remaining reviews were treated as training data (i.e. a first data portion). In order to avoid selecting redundant sentences commenting on the same aspect, the following strategy was proposed. After selecting each new sentence, the informativeness of the remaining sentences were updated as follows: the informativeness of a remaining sentence s, commenting on the same aspect with a selected sentence sᵢ was reduced by exp{η·similarity(sᵢ,sⱼ)}, where similarity(•) is the Cosine similarity between two sentences using unigram as feature. η is a trade-off parameter and was empirically set to 10 in the experiments. Three annotators were invited to generate the reference summaries for each product. Each annotator was invited to read the consumer reviews of a product and write a summary of up to 100 words individually by selecting the informative sentences based on his/her own judgements. ROUGE (i.e., Recall-Oriented Understudy for Gisting Evaluation) was adopted as the performance metric to evaluate the quality of the summary generated by the above methods. ROUGE measures the quality of a summary by counting the overlapping N-grams between it and a set of reference summaries generated by human.

$$R O U G E - N = \frac{{\sum }_{S ∈ \{ Reference Summaries \}} {\sum }_{{gram}_{n} ∈ S} {Count}_{match} ( {gram}_{n} )}{{\sum }_{S ∈ \{ Reference Summaries \}} {\sum }_{{gram}_{n} ∈ S} Count ( {gram}_{n} )} \qquad ( 4.22 )$$

Where n stands for the length of the n-gram, i.e., gramₙ. Count_{match}(gramₙ) is the maximum number of n-grams co-occurring in the candidate summary and the reference summaries. The summarization methods were counted using aspect ranking results as in Eq.(4.21) against the methods using the traditional scoring function in Eq.(4.15). In particular, four methods were evaluated: SR and SR_AR, i.e., Sentence Ranking with the traditional scoring function and the proposed function based on Aspect Ranking, respectively; GB and GB_AR, i.e., Graph-based method with the traditional and proposed scoring functions, respectively. The trade-off parameters λ₁, λ₂, α, and β were empirically set to 0.5, 0.5, 0.6, and 0.4, respectively. Here, summarization performance was reported in terms of ROUGE-1 and ROUGE-2 corresponding to unigrams and bigrams, respectively.

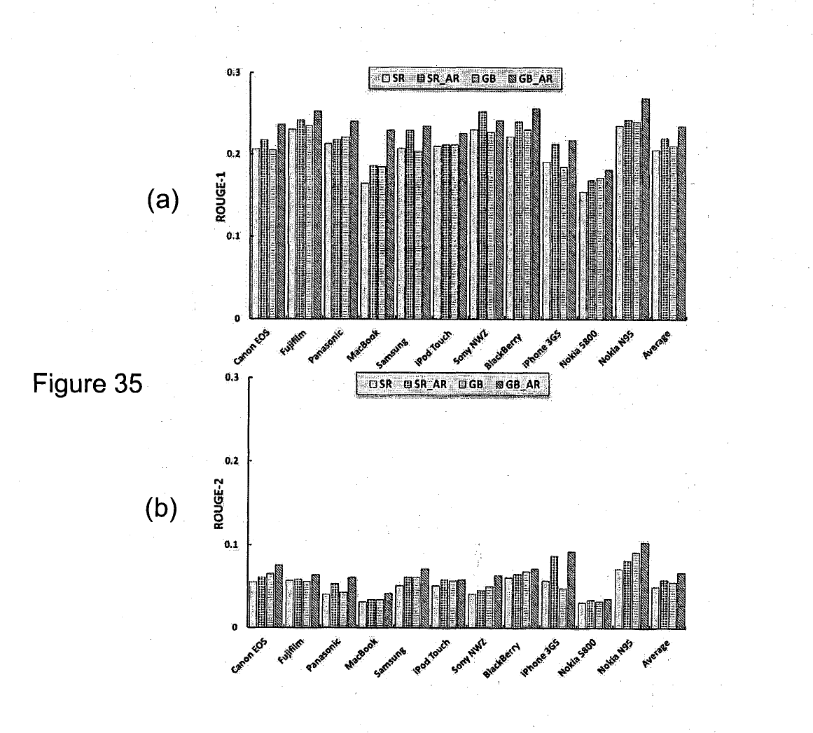

FIG. 35a shows the ROUGE-1 performance on each product as well as the average ROUGE-1 over all the 11 products, while FIG. 35b provides the corresponding performance in terms of ROUGE-2. From these results, it is possible to obtain the following observations:
By exploiting aspect ranking, the proposed SR_AR and GB_AR approaches outperforms the traditional SR and GB methods, respectively. In particular, SR_AR obtains performance improvements over SR by around 6.9% and 16.8% in terms of average. ROUGE-1 and ROUGE-2, respectively. GB_AR achieves around 11.7% and 21.4% improvements over GB in terms of average ROUGE-1 and ROUGE-2, respectively;
Considering the ROUGE-1 and ROUGE-2 results, SR_AR and GB_AR achieves better performance on all the 11 products compared to SR and GB, respectively;
The graph-based methods, i.e., GB_AR and GB, obtain slight performance improvements compared to the corresponding sentence ranking methods, i.e., SR_AR and SR.

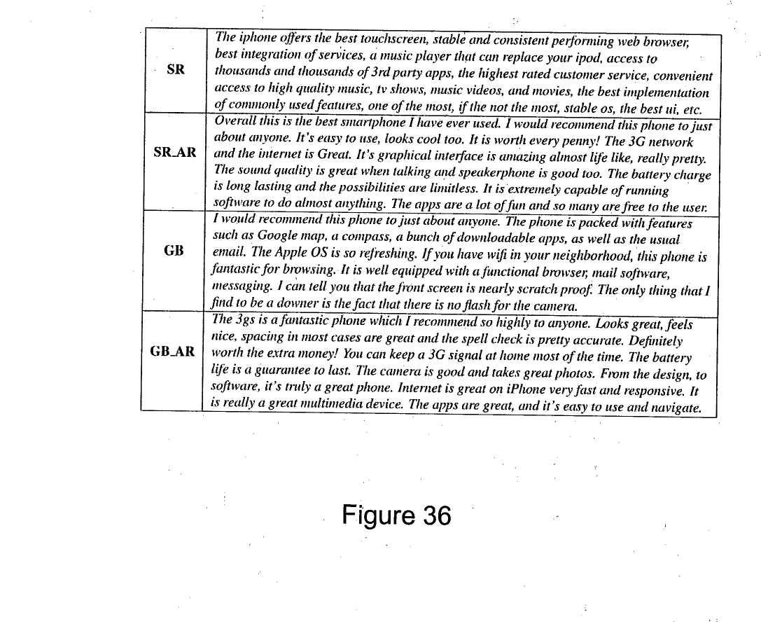

In summary, the above results demonstrate the capacity of aspect ranking in improving extractive review summarization. With the help of aspect ranking, the summarization methods can generate more informative summaries consisting of consumer reviews on the most important aspects. FIG. 36 illustrates sample summaries of the product iPhone 3GS. It can be seen that the summaries from the methods using aspect ranking, i.e. SR_AR and GB_AR, contain consumer comments on the important aspects, such as “easy to use,” “3G network.”, and are more informative than those from the traditional methods.

Summary

In the above-described embodiments, a product aspect ranking framework has been proposed to identify the important aspects of products from consumer reviews. The framework first exploits the hierarchy (as described previously) to identify the aspects and corresponding opinions on numerous reviews. It then utilizes a probabilistic aspect ranking algorithm to infer the importance of various aspects of a product from the reviews. The algorithm simultaneously explores aspect frequency and the influence of consumer opinions given to each aspect over the overall opinions. The product aspects are finally ranked according to their importance scores. Extensive experiments were conducted on the product review dataset to systematically evaluate the proposed framework. Experimental results demonstrated the effectiveness of the proposed approaches. Moreover, product aspect ranking was applied to facilitate two real-world tasks, i.e., document-level sentiment classification and extractive review summarization. As aspect ranking reveals consumers' major concerns in the reviews, it can naturally be used to improve document-level sentiment classification by giving more weights to the important aspects in the analysis of opinions on the review document. Moreover, it can facilitate extractive review summarization by putting more emphasis on the sentences that include the important aspects. Significant performance improvements were obtained with the help of the product aspect ranking.

Computer Network

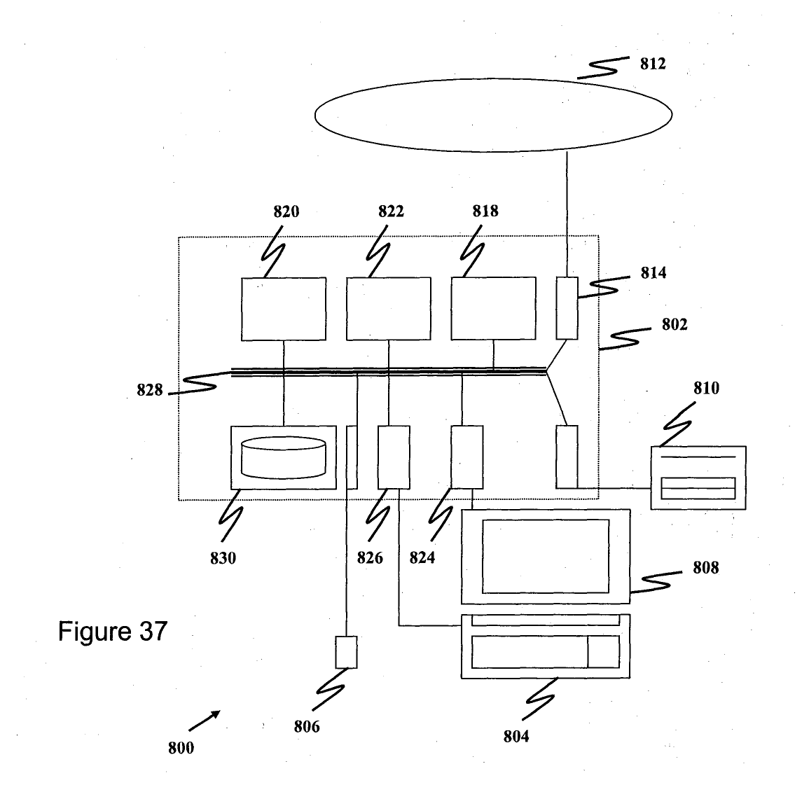

The above described methods according to various embodiments can be implemented on a computer system 800, schematically shown in FIG. 37. It may be implemented as software, such as a computer program being executed within the computer system 800, and instructing the computer system 800 to conduct the method of the example embodiment.

The computer system 800 comprises a computer module 802, input modules such as a keyboard 804 and mouse 806 and a plurality of output devices such as a display 808, and printer 810.

The computer module 802 is connected to a computer network 812 via a suitable transceiver device 814, to enable access to e.g. the Internet or other network systems such as Local Area Network (LAN) or Wide Area Network (WAN).

The computer module 802 in the example includes a processor 818, a Random Access Memory (RAM) 820 and a Read Only Memory (ROM) 822. The computer module 802 also includes a number of Input/Output (I/O) interfaces, for example I/O interface 824 to the display 808, and I/O interface 826 to the keyboard 804.

The components of the computer module 802 typically communicate via an interconnected bus 828 and in a manner known to the person skilled in the relevant art.

The application program is typically supplied to the user of the computer system 800 encoded on a data storage medium such as a CD-ROM or flash memory carrier and read utilizing a corresponding data storage medium drive of a data storage device 830. The application program is read and controlled in its execution by the processor 818. Intermediate storage of program data maybe accomplished using RAM 820.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for generating a modified hierarchy for a product based on data relating to the product, the method comprising:
generating an initial hierarchy for the product, the initial hierarchy comprising a plurality of nodes, each node representing a different product aspect, the plurality of nodes being interconnected in dependence on relationships between different product aspects;
identifying a product aspect from the data;
determining an optimal position in the initial hierarchy for the identified product aspect by computing an objective function; and
inserting the identified product aspect into the optimal position in the initial hierarchy to generate the modified hierarchy.

2. The method of claim 1, wherein the initial hierarchy is generated based on a specification of the product.

3. The method of claim 1, wherein the initial hierarchy comprises one or more node pairs, each node pair having a parent node and a child node connected together to indicate a parent-child relationship.

4. The method of claim 3, wherein the initial hierarchy comprises a root node and the parent node of the or each node pair is the node closest to the root node.

5. The method of claim 1, wherein identifying a product aspect from the data comprises extracting one or more noun phrases from the data.

6. The method of claim 5, further comprising classifying an extracted noun phrase into an aspect class if the extracted noun phrase corresponds with a product aspect associated with the aspect class, the aspect class being associated with one or more different product aspects.

7. The method of claim 5, further comprising clustering together multiple different extracted noun phrases, wherein each of the multiple different extracted noun phrases comprises a corresponding synonym term.

8. The method of claim 1, wherein determining the optimal position comprises:
inserting the identified product aspect in each of a plurality of sample positions in the initial hierarchy;
calculating a positioning score relating to each sample position, the positioning score being a measure of suitability of the sample position; and
determining the optimal position based on the positioning scores relating to each sample position.

9. The method of claim 8, wherein the positioning score is a measure of change in a hierarchy semantic distance, the hierarchy semantic distance being a summation of an aspect semantic distance for each node pair in the initial hierarchy, each aspect semantic distance being a measure of similarity between the meanings of the two product aspects represented by the node pair.

10. The method of claim 8, wherein the positioning score is a measure of change in the structure of the initial hierarchy.

11. The method of claim 8, wherein the positioning score is a measure of change between first and second aspect semantic distances relating to a node pair in the initial hierarchy, the first and second aspect semantic distances being a measure of similarity between the meanings of the two product aspects represented by the node pair, the first aspect semantic distance being calculated based on the initial hierarchy, the second semantic distance being calculated based on auxiliary data relating to the product.

12. The method of claim 1, wherein inserting the identified product aspect into the initial hierarchy comprises associating the identified product aspect with an existing node to indicate that the existing node represents the identified product aspect.

13. The method of claim 1, wherein inserting the identified product aspect into the initial hierarchy comprises interconnecting a new node into the initial hierarchy and associating the identified product aspect with the new node to indicate that the new node represents the identified product aspect.

14. The method of claim 1, further comprising:
determining an aspect sentiment for an identified product aspect based on the data; and
associating the aspect sentiment with the identified product aspect in the modified hierarchy.

15. The method of claim 14, wherein determining an aspect sentiment comprises:
extracting one or more aspect opinions from the data, the or each aspect opinion identifying the identified product aspect and a corresponding opinion;
classifying the or each aspect opinion into one of a plurality of opinion classes based on the corresponding opinion, each opinion class being associated with a different opinion; and
determining the aspect sentiment for the identified product aspect based on which one of the plurality of opinion classes contains the most aspect opinions.

16. The method of claim 15, wherein the plurality of opinion classes includes a positive opinion class and a negative opinion class.

17. An apparatus for generating a modified hierarchy for a product based on data relating to the product, the apparatus comprising:
at least one processor;
and at least one memory including computer program code;
the at least one memory and the computer program code configured to, with the at least one processor, cause the apparatus at least to:
generate an initial hierarchy for the product, the initial hierarchy comprising a plurality of nodes, each node representing a different product aspect, the plurality of nodes being interconnected in dependence on relationships between different product aspects;
identify a product aspect from the data;
determine an optimal position in the initial hierarchy for the identified product aspect by computing an objective function; and
insert the identified product aspect into the optimal position in the initial hierarchy to generate the modified hierarchy.

18. A computer-readable storage medium having stored thereon computer program code which when executed by a computer causes the computer to execute a method for generating a modified hierarchy for a product based on data relating to the product, the method being in accordance with claim 1.

19. A method for identifying product aspects based on data relating to the product, the method comprising:
identifying a data segment from a first portion of the data;
generating a modified hierarchy based on a second portion of the data, in accordance with the method of claim 1; and
classifying the data segment into one of a plurality of aspect classes, each aspect class being associated with a product aspect represented by a different node in the modified hierarchy to identify to which product aspect the data segment relates.

20. The method of claim 19, wherein classifying comprises determining a relevance score for each aspect class, the relevance score indicating how similar the data segment is to the product aspect associated with the aspect class.

21. The method of claim 20, wherein identifying to which product aspect the data segment relates comprises determining the aspect class having a relevance score that is lower than a predefined threshold value.

22. An apparatus for identifying product aspects based on data relating to the product, the apparatus comprising:
at least one processor;
and at least one memory including computer program code;
the at least one memory and the computer program code configured to, with the at least one processor, cause the apparatus at least to:
identify a data segment from a first portion of the data;
generate a modified hierarchy based on a second portion of the data using the apparatus of claim 17; and
classify the data segment into one of a plurality of aspect classes, each aspect class being associated with a product aspect represented by a different node in the modified hierarchy to identify to which product aspect the data segment relates.

23. A computer-readable storage medium having stored thereon computer program code which when executed by a computer causes the computer to execute a method for identifying product aspects based on data relating to the product, the method being in accordance with claim 19.

24. A method for determining an aspect sentiment for a product aspect from data relating to the product, the method comprising:
identifying a data segment from a first portion the data;
generating a modified hierarchy based on a second portion of the data, in accordance with the method of claim 1;
classifying the data segment into one of a plurality of aspect classes, each aspect class being associated with a product aspect represented by a different node in the modified hierarchy to identify to which product aspect the data segment relates;
extracting from the data segment an opinion corresponding to the product aspect to which the data segment relates; and
classifying the extracted opinion into one of a plurality of opinion classes, each opinion class being associated with a different opinion, the aspect sentiment being the opinion associated with the one opinion class.

25. The method of claim 24, wherein the plurality of opinion classes includes a positive opinion class and a negative opinion class.

26. An apparatus for determining an aspect sentiment for a product aspect from data relating to the product, the apparatus comprising:
at least one processor;
and at least one memory including computer program code;
the at least one memory and the computer program code configured to, with the at least one processor, cause the apparatus at least to:
identify a data segment from a first portion the data;
generate a modified hierarchy based on a second portion of the data using the apparatus of claim 17;
classify the data segment into one of a plurality of aspect classes, each aspect class being associated with a product aspect represented by a different node in the modified hierarchy to identify to which product aspect the data segment relates;
extract from the data segment an opinion corresponding to the product aspect to which the data segment relates; and
classify the extracted opinion into one of a plurality of opinion classes, each opinion class being associated with a different opinion, the aspect sentiment being the opinion associated with the one opinion class.

27. A computer-readable storage medium having stored thereon computer program code which when executed by a computer causes the computer to execute a method for determining an aspect sentiment for a product aspect from data relating to the product, the method being in accordance with claim 24.

28. A method for ranking product aspects based on data relating to the product, the method comprising:
identifying product aspects from the data;
generating a weighting factor for each identified product aspect based on a frequency of occurrence of the product aspect in the data and a measure of influence of the identified product aspect; and
ranking the identified product aspects based on the generated weighting factors.

29-37. (canceled)

38. An apparatus for ranking product aspects based on data relating to the product, the apparatus comprising:
at least one processor;
and at least one memory including computer program code;
the at least one memory and the computer program code configured to, with the at least one processor, cause the apparatus at least to: identify product aspects from the data;
generate a weighting factor for each identified product aspect based on a frequency of occurrence of the product aspect in the data and a measure of influence of the identified product aspect; and
rank the identified product aspects based on the generated weighting factors.

39-52. (canceled)
